(19) United States
(12) Patent Application Publication
(10) Pub. No.: US 2004/0022994 A1
(43) Pub. Date: Feb. 5, 2004

(54) Cushion back products and methods

(76) Inventors: Kenneth B. Higgins, LaGrange, GA (US); N. David Sellman, LaGrange, GA (US)

Correspondence Address: Milliken & Company, P.O. Box 1927, Spartanburg, SC, 29304, US

(21) Appl. No.: 10/212,580

(22) Filed: Aug. 5, 2002

(51) Int. Cl. D05C 17/00; B32B 33/00

(52) U.S. Cl. 428/95; 428/92

(57) ABSTRACT

An improved cushioned carpet fabric is provided. The cushioned carpet comprises a primary carpet having a primary base and a plurality of pile-forming yarns projecting outwardly from one side. A layer of reinforcement material is bonded to the primary base on the side opposite the pile forming yarns. The reinforcement layer is adjacent to and embedded in, a cushion layer of a polymer such as a polyurethane. There is preferably no additional adhesive between the cushion layer and the layer of reinforcement material. An apparatus and process for forming the cushioned carpet fabric are also provided.

### FIELD OF THE INVENTION

The present invention relates to cushion back, cushioned back or cushion backed carpet products such as roll product or carpet tile, especially such products particularly suitable for use in residential applications, and, more particularly, to carpet products having a polymer or foam backing preferably formed from a polyurethane-forming composition which is mated to a primary carpet fabric. Processes and apparatuses for forming and/or using the cushion backed carpet products of the present invention are also provided.

### BACKGROUND OF THE INVENTION

Cushion back carpet products or carpet tiles are described for example in U.S. Pat. Nos. 4,522,857 and 6,203,881 each hereby incorporated by reference herein.

The evolution of flooring in the commercial and residential markets has progressed in two distinct directions based substantially on the requirements of the end user. One aspect of the evolution of commercial floor coverings has been directed to modular floor coverings. The commercial market is exemplified by high traffic, both foot traffic and rolling equipment, and minimal demand for plush, high, pile. A particular problem with commercial applications is the formation of traffic lanes which cause a carpet to show wear in certain lanes of traffic with minimal wear in other areas. To avoid this visually distracting phenomenon, carpet designed for commercial applications has evolved into a material with low mat, minimal or no cushion, and the wide spread use of carpet tiles which can be individually replaced when damaged.

An excellent commercial cushion backed carpet tile or modular cushion back carpet product on the market today, for example, sold under the trademark Comfort Plus® by Milliken & Company of LaGrange, Ga. has a structure similar to, for example FIGS. 3A or 3B of U.S. Pat. No. 6,203,881 (incorporated by reference herein), and has a commercial primary carpet fabric with a face weight of about 20 to 40 oz/yd², a hot melt layer of about 38 to 54 oz/yd², a prime filled polyurethane foam cushion of about 0.10 to 0.2 inches thick, a cushion weight of about 28-34 oz/yd², a cushion density of about 16-18 lbs. per cubic foot, and an overall product height of about 0.4-0.8 inches. This superior commercial cushion back carpet tile provides excellent resilience and under foot comfort, exhibits performance characteristics that rate it for heavy commercial use, and has achieved a notable status throughout the industry as having excellent look, feel, wear, comfort, and cushion characteristics, performance, properties, and the like. Such cushion backed carpet tile is relatively expensive to produce due to the high quality and quantity of materials utilized.

Floor coverings in the form of broadloom carpet for residential use have demands which make a commercial carpet undesirable and these divergent requirements have encouraged a divergence in the technology for each market. The most critical parameters for a viable residential carpet is related to the way a carpet feels and looks. This need has only been met previously with a secondary cushion, or pad, and a deep pile broadloom carpet. Residential carpet is almost exclusively broadloom or wall-to-wall carpet.

While broadloom carpet meets the aesthetic and comfort requirements for residential use, there are deficiencies which have not been met in the art. The installation of broadloom carpet requires several steps including: a) installation of tack strips around the border of the area to be carpeted; b) installation of a cushion, or pad, in the area to be carpeted; c) overlaying the broadloom carpet over the pad, without displacing the pad; d) seaming the broadloom carpet pieces together, and e) stretching the carpet and securing it in place by forcing the tack strip through the carpet. This installation requires trained individuals and involves the use of large, bulky, rolls of 12-14 foot wide broadloom carpet and pad. Once a broadloom carpet is soiled or damaged, the entire carpet must be removed for refurbishment or replacement.

Although attempts have been made in the past at marketing certain carpet tile products for use in the home, such as hardback carpet tiles for the kitchen, such attempts have not been successful. Hence, the residential carpet customer has been substantially limited in the choice of home carpet products, for example, to broadloom carpet installed by professional installers over a separate broadloom carpet pad. Many consumers have foregone carpet completely and have opted for linoleum, hardwood or interlocking simulated wood panels, commonly referred to as Pergo flooring, since the choice in carpet does not provide a suitable alternative.

Due to the conflicting demands of carpet for commercial applications and carpet for residential applications advancements in commercial products have not translated directly to suitable products for residential use.

Carpet and carpet tiles having cushioned backings are well known to those of skill in the art. Such cushioned backed carpet is disclosed, for example in U.S. Pat. Nos. 4,522,857 and 6,203,881 (each hereby incorporated by reference herein). An example of a prior art tufted carpet product is illustrated in FIG. 1A and an example of a prior art bonded carpet product is illustrated in FIG. 1B herein. In the prior art tufted carpet, a primary carpet fabric 12 is embedded in an adhesive layer 16 in which is embedded a layer of glass scrim or nonwoven material. A foam base composite 19 is likewise adhesively bonded to the adhesive layer 16. In the prior art tufted carpet illustrated in FIG. 1A, the primary carpet fabric 12 includes a loop pile layer 20 tufted through a primary backing 22 by a conventional tufting process and held in place by a precoat backing layer of latex 24 or other appropriate adhesive including a hot melt adhesive or the like. The foam base composite 19 of the prior art tufted carpet product preferably includes an intermediate layer 26 molded to a layer of urethane foam 28 as illustrated.

The bonded carpet product (FIG. 1B) formed according to the prior art employs the same type of foam base composite 19 adhesively bonded by adhesive laminate layers 16. However, the primary carpet fabric 12 has somewhat different components from that of the tufted product in that it preferably comprises cut pile yarns 34 implanted in a PVC, latex, or hot melt adhesive 36 having a woven or nonwoven reinforcement or substrate layer 38 of fiberglass, nylon, polypropylene or polyester.

The practice utilized in forming the product disclosed in the above mentioned U.S. Pat. No. 4,522,857 patent and other known products involves preforming and curing the foam base composite 19 of urethane foam and backing material by practices such as are disclosed in U.S. Pat. Nos. 4,171,395, 4,132,817 and 4,512,831, to Tillotson (all hereby incorporated by reference herein). In the present practice, only after this foam base composite is formed and cured to some degree as a modular component, is it laminated to the carpet base or the stabilizing layer.

As will be appreciated, the cost associated with such modular formation and assembly practices may be reduced by a simplified operation in which a primary carpet fabric, either with or without a stabilizing layer of scrim or the like, is laid directly into a polyurethane-forming composition and thereafter curing the polyurethane. The process can be made even more efficient if the polyurethane-forming composition requires no pre-curing prior to joining the carpet base.

Prior to the present invention, the known processes directed to the application of the polyurethane cushioned backings to fabric substrates have relied on the extremely close control of temperature in both the polyurethane composition and the adjoined fabric layer to effect stability through pre-cure of the polyurethane prior to lamination of the primary carpet to form a composite structure. Such pre-cure has been largely considered necessary in order to yield a stable foam structure to which the primary carpet backing could be applied. The application of heat to the polyurethane composition prior to joinder of the heated fabric backing causes polymer cross linking which has heretofore been thought to be necessary to stabilize the foam mixture to a sufficient degree to prevent the collapse of the foam.

The present invention also provides a particularly simple composite structure amendable to continuous, in-line or in-situ formation of a stable cushion carpet composite which prior to U.S. Pat. Nos. 5,540,968, 5,545,276, 5,948,500, and 6,203,881 (all hereby incorporated by reference herein) was not believed to have been previously utilized. Specifically, it has not been previously recognized that a single process could be used to bring all the layers of the cushioned carpet composite together by laying a primary carpet fabric, either with or without some degree of preheat, directly into a mechanically frothed polyurethane-forming composition prior to curing the polyurethane and without an intermediate layer of material.

As indicated, the prior art carpet forming processes typically require the separate formation of a foam base composite comprising a backing layer and a layer of urethane foam. The backing layer is then used as an intermediate layer to which a primary carpet fabric and reinforcing layer can be adhesively bonded.

In a potentially preferred practice of the present invention, the base of the primary carpet fabric is adhesively bonded to a layer of non-woven glass reinforcement material to form a preliminary composite. A puddle of polyurethane-forming composition is simultaneously deposited across a nonwoven backing material. The preliminary composite and the polyurethane-forming composition are thereafter almost immediately brought together with the preliminary composite being laid into, and supported by, the polyurethane-forming puddle. The entire structure is then heated to cure the polyurethane forming composition. The preliminary composite may be slightly heated to about 120° F. to improve heating efficiency although the process may likewise be carried out without such preheating.

It is to be understood that, as with the prior art products, wherein the primary carpet fabric 12 may have different embodiments, the component structure of the primary carpet fabric for the present invention is preferably a pile fabric such as a residential type carpet. Rather it is intended that any primary carpet fabric having a pile-forming portion and a primary base may be utilized as the primary carpet fabric. By “primary base” is meant any single layer or composite structure including, inter alia, the commonly used layered composite of primary backing 22 and latex precoat 24 previously described in relation to the prior art tufted product (FIG. 1A) and the adhesive layer 36 with reinforcement substrate 38 previously described in relation to the prior art bonded product (FIG. 1B). As will be appreciated, the use of polyester in the primary base structure may be desirable due to the eventual heat curing such structure may undergo. Other embodiments as may occur to those of skill in the art may, of course, also be utilized. For example, in the bonded product, the pile forming yarns could be heat tacked to the substrate 38 as disclosed in U.S. Pat. No. 5,443,881 (hereby incorporated by reference) to permit simplified construction of a primary carpet.

### SUMMARY OF THE PRESENT INVENTION

Applicant has discovered that there has been a long-standing need and desire for a modular product or carpet tile which has the look and feel of a residential deep pile carpet over pad. The attributes that render a carpet suitable for use in residential are in conflict with those properties which make for a commercial carpet tile. For example, a residential carpet must be sufficiently plush and padded to meet the needs of the residential consumer. Too much cushioning in a commercial carpet tile is detrimental to the performance. For example, when a weight is placed near the edge of a carpet tiles, the edge deflects thereby causing a ledge between the carpet tile with the weight and the adjacent carpet tile. The ledge creates many problems. Tiles can slide over one another, often referred to as “snow-plowing”. When the edges of adjacent carpet tiles separate in a vertical direction the edge fibers can enter the crevice created by the separation. As the edges attempt to realign, the fibers are trapped in the crevice and appear to be matted. This renders the seam highly visible. In severe cases the separation can be a tripping hazard.

Further, Applicants are unaware of any modular carpeting product which has fully satisfied the needs of adequate cushioning, plush pile, and minimal edge displacement, and is durable with use relevant to a residential installation.

According to one aspect of the present invention, a floor covering system is provided including modular surface covering elements including a pile face suitable for installation and use in a residential application.

According to another aspect of the invention, a method is provided for forming a residential modular carpet and carpet tile having resilience, under foot comfort, the look and feel of broadloom carpet, seamless appearance when installed, which is easy to install, can be installed by the homeowner, and has performance characteristics that rate it for residential or home use.

According to another aspect of the present invention, a flooring system is provided including modular surface covering elements of geometry to facilitate cooperative arrangement of elements across a flooring surface so as to obscure the appearance of seams between elements.

It is a general object of at least one embodiment of the present invention to provide a carpet product including a foam cushioned backing formed in a continuous process, in-line or in-situ and which in at least one embodiment is suitable for residential use.

It is an object of at least one embodiment of the present invention to provide a cushioned carpet and carpet tile composite wherein a reinforcement layer is disposed, at least partially, within a polymer mass which is adjacent a primary carpet with such primary carpet being laid in-situ into a puddle of the polymer without a pre-curing operation.

At least one embodiment of the present invention provides a residential carpet tile or roll product which addresses the disadvantages of prior carpet products.

At least one embodiment of the present invention provides a residential carpet tile product having a residential type face such as a plush, cut pile, primary carpet fabric, hot melt tie coat, fiberglass reinforcement layer, foam cushion, and a felt backing material with or without an adhesive, grip or tack layer.

It is another object of at least one embodiment of the present invention to provide a carpet tile having a frieze, cut pile carpet with a yarn face weight of about 10-75 oz/yd².

It is a further object of at least one embodiment of the present invention to provide a residential carpet and carpet tile having a polyurethane cushion.

It is a further object of at least one embodiment of the present invention to provide a residential modular carpet and carpet tile having resilience and under foot comfort.

It is another object of at least one embodiment to provide a modular carpet product installation which substantially has the look and feel of residential broadloom carpet over broadloom pad.

It is still another object of at least one embodiment of the present invention to provide a modular carpet and carpet tile exhibiting performance characteristics that rate it for residential or home use.

It is another object of at least one embodiment of the present invention to provide a method of forming a residential modular carpet and carpet tile having resilience, under foot comfort, the look and feel of broadloom carpet, seamless appearance when installed properly, which is easy to install, can be installed by the homeowner, facilitates do-it-yourself (D-I-Y) purchase and installation, and/or having performance characteristics that rate it for residential or home use.

It is a further object of at least one embodiment of the present invention to provide a process for the formation of a residential foam backed or cushioned carpet tile including a primary carpet fabric, a reinforcement layer, a polyurethane cushion material, and a backing layer.

It is yet another object of at least one embodiment of the present invention that the residential carpet tile of the present invention may be tufted or dyed or printed with solid colors, orientation independent designs or patterns, or designs or patterns having the ability to seam properly without cutting the tiles in register with the design and to allow the carpet tile to be installed monolithically as well as by conventional quarter turn “Parquet” or by Ashlar (brick) techniques with or without floor adhesives.

In accordance with an exemplary object of at least one embodiment of the present invention, a residential modular carpet tile has a shape of at least one of square, rectangular, straight sides with chevron ends, straight sides with multiple chevron ends, single or multiple chevron sides and ends, chevron sides with straight ends, multiple chevron sides with straight ends, triangular, diamond, hexagonal, octagonal, bone, double axe head, tomahawk, sine wave edge (two or more sides), crescent, or the like.

In accordance with a particular object of at least one embodiment of the present invention, a residential modular carpet composite, for example 6 feet or 12 feet wide, is cut into selected lengths, sheets, rolls, mats, runners, rugs, or modular carpet tiles such as shaped tiles, rectangles or squares, for example, 18 inches×18 inches, 23 inches×23 inches, 24 inches×24 inches, 18 inches×24 inches, 18 inches×36 inches, 23 inches×36 inches, 24 inches×36 inches, 36 inches×36 inches, 50 cm×50 cm, 1 meter×1 meter, 48 inches×48 inches, sheets of, for example, 4 feet×8 feet or 4 feet×12 feet, or rolls, for example, 2 feet×20 feet, 3 feet×25 feet, 4 feet×50 feet, 6 feet×100 feet, or the like.

Also, in accordance with another object of at least one embodiment of the present invention, the residential carpet tile of the present invention may be installed on site or on flooring or subflooring such as concrete, wood, partical board, tile, vinyl, laminate, hardwood, or the like, by any one of the conventional installation techniques as well as can be constructed for adhesive-free installation, self-stick, releasable adhesive, double sided tape, releasable fastening means, permanent adhesive, or the like.

In accordance with at least one embodiment of the present invention, a residential cushioned carpet tile is provided with a friction or adhesion enhancing backing surface, material, or composite such as a textured or embossed surface, a tacky surface, an adhesive surface such as a coating or surface treatment, a magnetic sheet, magnetic strips, and/or the like.

In accordance with at least one embodiment of the present invention, there is provided a residential, stabilized, foam or cushion backed carpet such as 4 foot×4 foot cushioned sheets or tiles, 36 inch×36 inch tiles, 1 meter×1 meter tiles, rectangular tiles, shaped tiles, rolls, mats, rugs, runners, and the like.

It is a further object of at least one embodiment of the present invention to provide a modular carpet and carpet tile having resilience and under foot comfort.

It is yet another object of at least one embodiment of the present invention that the carpet and carpet tile of the present invention may be dyed, printed, woven, tufted, or the like with orientation independent designs or designs having the ability to seam properly without cutting the tiles in register with the design and to allow the carpet to be installed monolithically as well as by conventional quarter turn “Parquet” or by Ashiar (brick) techniques with or without floor adhesives.

In accordance with an exemplary object of at least one embodiment of the present invention, a modular carpet composite which may be cut to form modular carpet tiles includes a primary carpet or greige carpet has, for example, a face weight of about 10-75 oz/yd², more preferably 20-45 oz/yd², and most preferably 29-45 oz/yd²; a hot melt layer of less than or equal to about 70 oz/yd², and a cushion of about 1-18 mm thick, more preferably 4-12 mm thick and most preferably 5-8 mm thick. The cushion may have a density of about 25 lbs. per cubic foot or less, more preferably about 3-25 lbs. per cubic foot, more preferably 5-15 lbs. per cubic foot, and most preferably 6-8 lbs. per cubic foot.

In accordance with a particular object of at least one embodiment of the present invention, a modular carpet composite, for example about 6 feet to 14 feet wide, is cut into modular carpet tiles or carpet squares, for example, 18 inches×18 inches, 36 inches×36 inches, 50 cm×50 cm, 1 meter×1 meter, 48 inches×48 inches, or the like.

Also, in accordance with another object of at least one embodiment of the present invention, the carpet tile of the present invention may be installed on site or on flooring by any of the conventional installation techniques as well as can be constructed for adhesive-free installation, self-stick, or the like.

Also, in accordance with still another object of at least one embodiment of the present invention, the carpet tile of the present invention may be dyed, printed, tufted or woven with orientation dependent designs or designs having the ability to seam properly which require the tiles to be cut in register with the design and allow the carpet to be installed monolithically with or without floor adhesives.

In accordance with at least one embodiment of the present invention, a modular carpet tile is manufactured by:

tufting broadloom at a weight of about 10-75 oz/yd² or less,

printing a design in broadloom form,

applying a cushion backing system, and

cutting into carpet tiles.

In accordance with at least one embodiment, there is provided a residential carpet tile or carpet product that can preferably be installed on a residential floor with a substantially seamless appearance (no visible seams). There are one or more features of the present invention which may insure that the tile seams are virtually invisible to an observer in a room:

1. Substantially equal density of yarn at the tile joint or seam line compared to the interior surface of the tile.

2. Cutting the product with controlled depth cutting from the back that cuts through the carpet backing and not through the yarn. Nearly about 80% to 100% of the yarn is preserved at the cut edge.

3. A cut pile construction allows for controlled depth cutting.

4. A lot of yarn that extends past the vertical plane of the tile edge allows the modular units to look nearly seamless immediately after installation.

5. Use of high twist frieze yarn, a yarn that wants to spill over the edge of the vertical tile plane. The liveliness of this yarn and density of the carpet pile creates a lateral force that pushes the yarn past the tile edge.

6. A non-linear edge on a non-square shaped tile minimizes the continuous linear segment lengths of a tile joint. This further breaks up the tile seam line and makes it less noticeable to the human eye.

7. An installation method that off-sets the position of the tile into a brick-like or Ashlar pattern also reduces the continuous linear segment length of tile joints.

8. The tiles are cut so that they abut or join with limited space or gaps there between.

9. The face can be selected to hide the seams.

10. The tiles are constructed to be durable so that the seams do not show over time or with wear.

It is a related object of at least one embodiment of the present invention to provide a cushioned carpet composite wherein a primary carpet fabric is joined to a reinforcement layer and laid in-situ into a polyurethane-forming composition which has not undergone a pre-cure operation.

It is a further related object of at least one embodiment of the present invention to provide a continuous process for the in-line or in-situ formation of a cushioned carpet composite wherein a reinforcement layer is adhered to the base of a primary carpet fabric simultaneously with the application of a polyurethane-forming composition to a nonwoven backing layer and the primary carpet fabric with the adhered reinforcement layer is laid into the polyurethane-forming composition prior to curing the polyurethane-forming composition to form the carpet composite.

It is still a further related object of at least one embodiment of the present invention to provide a continuous process for the in-situ formation of a cushioned carpet composite wherein a reinforcement layer is adhered between a primary carpet base and a backing layer through the in-situ application of a polyurethane forming composition without the need for an intermediate adhesion step.

It is still a further related object of at least one embodiment of the present invention to provide an apparatus for carrying out the continuous, in-line or in-situ formation of a cushioned carpet composite.

Accordingly, it is a feature of at least one embodiment of the present invention to provide a cushioned carpet composite including a primary carpet fabric in laminar relation to a reinforcement layer wherein such reinforcement layer is at least partially embedded in a polyurethane foam layer which is disposed adjacent to a nonwoven backing layer. The reinforcement layer may be bonded to the base of the primary carpet fabric by the polyurethane foam or by a separate adhesive.

It is a further feature of at least one embodiment of the present invention to provide a process for forming a cushioned carpet composite including the simultaneous continuous steps of adhering a woven or non-woven reinforcement material to the base of a primary carpet fabric; depositing a puddle of a polyurethane-forming composition across a backing layer or support structure and laying the primary carpet fabric and adhered reinforcement material into the puddle of polyurethane-forming composition deposited on the backing layer.

It is a subsidiary feature of at least one embodiment of the present invention to provide a single step process for forming a cushioned carpet composite including applying a polyurethane-forming composition adjacent a primary carpet fabric and a nonwoven backing layer with the polyurethane-forming composition at least partially holding an intermediate layer of reinforcement material.

It is yet a further feature of at least one embodiment of the present invention to provide an apparatus for use in the continuous in-situ formation of a cushioned carpet composite wherein the apparatus includes a polymer application unit for depositing a polyurethane-forming composition or other suitable polymer in combination with an adhesive application apparatus for adhering a reinforcement layer to the base of a primary carpet fabric. The polymer application unit and the adhesive application unit being simultaneously operable in controlled relation to one another such that the primary carpet with the adhered reinforcement layer may be laid directly into the polymer.

In accordance with at least one aspect of the present invention, a cushioned carpet is provided. The cushioned carpet comprises a primary carpet having a primary base and a plurality of pile-forming yarns projecting outwardly from one side. A layer of reinforcement material is bonded to the primary base on the side away from the pile-forming yarns. The reinforcement material is adjacent to, and embedded at least partially in, a cushion layer of polymer such as polyurethane. There is preferably no additional adhesive between the cushion layer and the layer of reinforcement material. An optional backing material is preferably disposed on the underside of the cushion layer. The backing material may include an adhesive, grip or tack backing on the side away from the cushion layer.

In accordance with at least one aspect of the present invention, a process for making a cushioned carpet is provided. The process involves obtaining a primary carpet fabric comprising a plurality of pile-forming yarns extending outwardly from one side of a primary base. A layer of reinforcement material is adhered to the primary carpet fabric on the side from which the pile-forming yarns do not extend, thereby forming a preliminary composite. A puddle of polymer such as a polyurethane-forming composition is applied to one side of a backing material and preferably doctored to desired thickness. The preliminary composite is then laid into the puddle of polymer without curing. Following this mating operation the polymer is preferably heat cured and the carpet is rolled or cut into tiles.

In accordance with at least one aspect of the present invention, an apparatus for use in forming a cushioned carpet composite is provided, comprising: a reinforcement bonding unit for bonding a layer of reinforcement material to the underside of a primary carpet fabric to form a preliminary carpet composite; a polymer application unit for dispersing a polyurethane-forming composition across the surface of a carrier fabric; a mating unit for laying said preliminary carpet composite into said polyurethane-forming composition; and means for heat curing the polyurethane-forming composition subsequent to said preliminary composite being laid into said polyurethane-forming composition; wherein said reinforcement bonding unit, said polymer application and said mating unit are preferably operable in a continuous, simultaneous manner.

A particularly preferred embodiment is provided in a modular carpet tile comprising a primary residential carpet face. The carpet tile further comprises a primary carpet fabric comprising a primary backing. The primary backing comprises a multi-component structure of a woven layer and a non-woven material needle punched through the woven layer. The primary carpet fabric has a pile side and an underside with a plurality of pile forming yarns projecting outwardly from the pile side and the primary carpet fabric has a face weight of 10-75 oz/yd². An adhesive layer is provided consisting essentially of at least one adhesive extending away from said underside of said primary carpet fabric. A layer of stabilizing material is provided in contacting relationship with the adhesive layer such that the layer of stabilizing material is held in place at a fixed position below the primary carpet fabric. The adhesive layer and/or stabilizing material form a load distribution layer. A foam cushion layer is bonded to the layer of stabilizing material wherein the cushion layer has a thickness of about 1-18 mm and the cushion layer has a density of about 25 lbs. per cubic foot or less.

Another preferred embodiment is provided in a dimensionally stable cushioned carpet tile suitable for disposition as discrete modular units across a subfloor or flooring surface. The carpet tile comprises a stabilized composite structure bonded to an underlying foamed cushion layer of polyurethane. The stabilized composite is comprised of a primary carpet fabric comprising a primary backing which further comprises a fused multi-component structure of a woven layer and a non-woven material needle punched through the woven layer. The primary carpet has a pile side and an underside with a plurality of pile forming yarns projecting outwardly from the pile side. An adhesive layer is provided consisting essentially of at least one resilient adhesive directly bonded to, and extending away from, the underside of the primary carpet fabric. A layer of stabilizing material is in contacting relationship with the resilient adhesive such that the layer of stabilizing material is held in place at a fixed position below the primary carpet fabric. The foam cushion layer having been cured in contact with the layer of stabilizing material such that the foamed cushion layer is bonded to the stabilized composition structure and at least a portion of the layer of stabilized material extends below the surface of the foamed cushion layer thereby being embedded within the foamed cushion layer.

Another preferred embodiment is provided in a floor comprising a plurality of cushioned carpet tiles suitable for disposition as discrete modular units across a subfloor. Each carpet tile comprises a primary carpet fabric. The primary carpet fabric comprises a primary backing comprising a fused multi-component structure of a woven layer and a non-woven material needle punched through the woven layer and having a pile side and an underside and having a plurality of pile forming yarns projecting outwardly from the pile side. An adhesive layer is provided consisting essentially of at least one adhesive directly bonded to and extending away from the underside of the primary carpet fabric. A layer of stabilizing material is in contacting relationship with the adhesive such that the layer of stabilizing material is held in place by the adhesive at a fixed position below the underside of the primary carpet fabric so as to provide dimensional stability to the carpet tile. A cured foamed cushion layer of polyurethane is disposed adjacent to the stabilizing material, the foam having been cured in contact with the stabilizing material so as to provide a contact surface for the foam such that the stabilizing material is at least partially embedded in and bonded to the cured foam. A textile secondary backing material is disposed adjacent to the surface of the foam cushion layer facing.

Yet another preferred embodiment is provided in a modular carpet tile comprising a primary residential carpet face. The tile further comprises a primary carpet fabric having a pile side and an underside with a plurality of pile forming yarns projecting outwardly from the pile side and the primary carpet fabric has a face weight of 10-75 oz/yd². An adhesive layer consisting essentially of at least one resilient adhesive extends away from the underside of the primary carpet fabric. A layer of stabilizing material is in contacting relationship with the adhesive layer such that the layer of stabilizing material is held in place at a fixed position below the primary carpet fabric. A foam cushion layer is bonded to the layer of stabilizing material wherein the cushion layer has a thickness of about 1-18 mm and the cushion layer has a density of about 25 lbs. per cubic foot or less. An adhesive, tack or grip having a vertical grip of about 0-5 psi and a lateral grip of about 0.05-5 psi is provided on the bottom of the cushion layer or on the bottom of a release layer.

Yet another preferred embodiment is provided in a dimensionally stable cushioned carpet tile suitable for disposition as discrete modular units across a flooring surface. The carpet tile comprises a stabilized composite structure bonded to an underlying foamed cushion layer of polyurethane. The stabilized composite is comprised of a primary carpet fabric having a pile side and an underside with a plurality of pile forming yarns projecting outwardly from the pile side wherein the primary carpet fabric has a face weight of about 10-75 oz/yd². An adhesive layer is provided consisting essentially of at least one resilient adhesive directly bonded to and extending away from the underside of the primary carpet fabric. A layer of stabilizing material is in contacting relationship with the resilient adhesive such that the layer of stabilizing material is held in place at a fixed position below the primary carpet fabric. A secondary backing is provided. The foam cushion layer is preferably cured in contact with the layer of stabilizing material such that the foamed cushion layer is bonded to the stabilized composition structure and at least a portion of the layer of stabilized material extends below the surface of the foamed cushion layer thereby being embedded within the foamed cushion layer.

Yet another preferred embodiment is provided in a process for forming a modular carpet tile comprising a primary residential carpet face. The process comprising the steps of:

a) forming a modular carpet tile precursor comprising:

i) a primary carpet fabric having a pile side and an underside with a plurality of pile forming yarns projecting outwardly from said pile side;

ii) an adhesive layer consisting essentially of at least one resilient adhesive extending away from said underside of said primary carpet fabric;

iii) a layer of stabilizing material in contacting relationship with said adhesive layer such that said layer of stabilizing material is held in place at a fixed position below said primary carpet fabric; and

iv) a foam cushion layer bonded to said layer of stabilizing material wherein said cushion layer has a thickness of about 1-18 mm and said cushion layer has a density of about 25 lbs. per cubic foot or less;

b) passing said modular carpet tile precursor through a cutting station wherein said cutting station comprises a cutting element and a strike plate; and

c) contacting said carpet precursor with said cutting element opposite to said pile side to separate or divide said modular carpet tile precursor into modular carpet tiles.

### BRIEF DESCRIPTION OF THE DRAWINGS

FIG. 1A is a cut-away view of a prior art tufted carpet with a cushioned composite structure.

FIG. 1B is a cut-away side view of a prior art bonded carpet incorporating a cushioned composite structure.

FIG. 2 is a schematic view illustrating a potentially preferred embodiment of the apparatus and process of the present invention.

FIGS. 3A, 3C and 3D are respective cut-away side views of tufted carpet incorporating a potentially preferred structure formed by the apparatus and process of the present invention as illustrated in FIG. 2.

FIG. 3B is a cut-away side view of a bonded carpet incorporating a potentially preferred structure formed by the apparatus and process of the present invention as illustrated in FIG. 2.

FIG. 4A is a cut-away side view of an alternative embodiment of a tufted carpet having no reinforcement layer.

FIG. 4B is a cut-away side view of an alternative embodiment of a bonded carpet having no reinforcement layer.

FIG. 5 is a schematic view illustrating an alternative apparatus and process according to the present invention for forming a cushioned carpet composite without separate adhesive bonding between the primary carpet and the reinforcement layer.

FIG. 6A is a cut-away side view of an alternative structure for a tufted carpet formed by the apparatus and process illustrated in FIG. 5.

FIG. 6B is a cut-away side view of an alternative structure for a bonded carpet formed by the apparatus and process illustrated in FIG. 5.

FIG. 7 is a schematic view illustrating yet another alternative apparatus and process according to the present invention for forming a cushioned carpet composite without separate adhesive bonding between the primary carpet and the reinforcement layer as illustrated in FIGS. 6A and 6B.

FIG. 8 is a schematic top plan view of a shaped carpet tile having a double chevron on two opposing sides thereof (with dimensions in inches).

FIG. 9 is a schematic top plan view of a plurality of the shaped tile of FIG. 8 installed with adjacent rows of tiles being offset by one-half of the tile widths over a subfloor or floor.

FIG. 10 is a schematic top plan view of a plurality of shaped carpet tiles with each tile having a single chevron on two opposing sides.

FIG. 11 is a schematic top plan view of a plurality of shaped carpet tiles with each tile having a triple chevron on two opposing sides thereof.

FIG. 12 is a schematic top plan view of a plurality of shaped carpet tiles with each tile having a single chevron on all four sides thereof;

FIG. 13 is a schematic top plan view of a plurality of shaped carpet tiles with each tile having a curved element on all four sides thereof;

FIG. 14 is a schematic top plan view of a plurality of square carpet tiles arranged aligned (monolithically) over a floor or subsfloor;

FIG. 15 is a schematic top plan view of a plurality of square carpet tiles arranged in offset rows (brick or Ashlar);

FIG. 16 is a schematic top plan view of a plurality of rectangular carpet tiles;

FIG. 17 is a schematic top plan view of a plurality of triangular carpet tiles;

FIG. 18 is a schematic top plan view of a plurality of diamond shaped carpet tiles;

FIG. 19 is a schematic top plan view of a plurality of hexagonal shaped carpet tiles;

FIG. 20 is a schematic top plan view of another exemplary example of a shaped carpet tile having a double chevron on two opposing sides or ends thereof (with dimensions in inches);

FIG. 21 is a schematic top plan view of a cutting pattern of cutting the carpet tile;

FIG. 22 is a schematic top plan view of a monolithic installation of the tiles;

FIG. 23 is a schematic top plan view of an Ashlar type installation of the tiles with edge tiles or cut tile pieces finishing out the installation;

FIGS. 24A and 24B relate to one embodiment of controlled depth or partial depth cutting of carpet tiles;

FIG. 24A is a schematic side view illustration of an ultrasonic double-sided blade ready to engage a carpet composite that is to be cut, for example, into individual carpet tiles;

FIG. 24B is a schematic side view illustration of the ultrasonic double-sided blade of FIG. 24A cutting through just the backing of the carpet composite of FIG. 24A;

FIGS. 25A and 25B relate to an alternative embodiment of a process of controlled depth cutting of carpet tiles;

FIG. 25A is a schematic side view illustration of a cutting blade such as a die blade ready to cut through the backing of a carpet composite such as a carpet tile precursor.

FIG. 25B is a schematic side view of the cutting blade of FIG. 25A cutting through the backing of the carpet composite (but not cutting the face yarn).

FIGS. 26A and 26B relate to another particular alternative embodiment of a process of controlled depth cutting of carpet pieces or carpet tiles.

FIG. 26A is a schematic side view illustration of a cutting blade such as a die blade ready to cut through the backing of a carpet composite with the face yarns directed away from the cutting blade.

FIG. 26B is a schematic side view of the apparatus of FIG. 26A with the cutting blade or die cutting through the backing of the carpet composite and with a raised set of reciprocating pins of a strike plate pressed up into the face yarn to hold the carpet in place while still allowing the blade to cut through the backing and not cut the face yarns.

FIGS. 27A-29 are cut-away side view illustrations of various multi-layered constructions for surface covering elements for disposition across a subfloor.

FIG. 30 is a side view illustration of a back to back packaging arrangement for surface covering elements having a pile face.

FIG. 31 is a side view illustration of a back to face packaging arrangement for surface covering elements having a pile face such as may occur in a roll.

FIG. 32 is a graph showing average gap length between surface covering elements of various constructions.

While the invention will be described and disclosed in connection with certain preferred embodiments and procedures, it is by no means intended to limit the invention to such specific embodiments and procedures. Rather it is intended to cover all such alternative embodiments, procedures, and modifications thereto as may fall within the true spirit and scope of the invention as defined and limited only by the appended claims.

### DETAILED DESCRIPTION

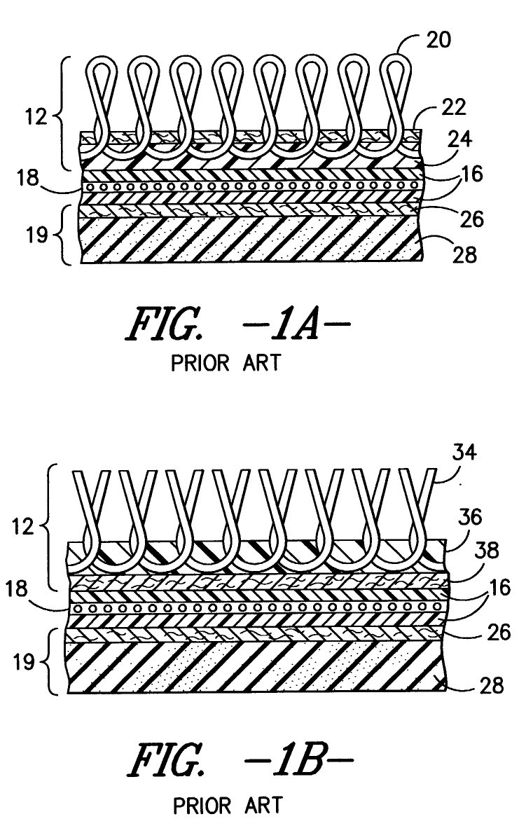

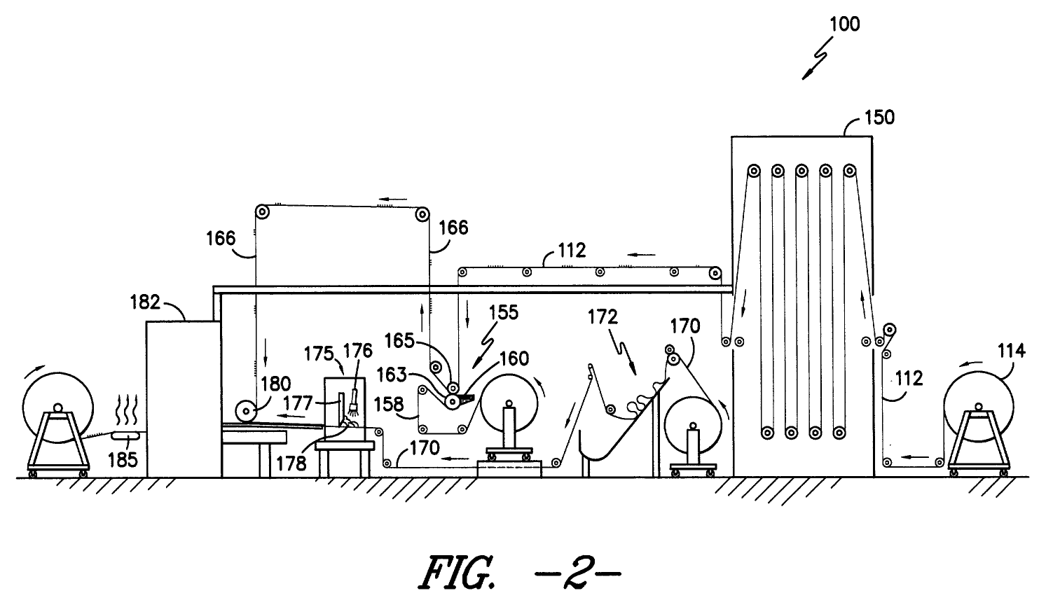

A schematic view illustrating a potentially preferred apparatus and process used in forming the cushioned carpet of the present invention is illustrated in FIG. 2. The apparatus is designated generally by reference numeral 100. As illustrated, a primary carpet fabric 112 which may incorporate either a tufted or a bonded configuration as described above is drawn from a mounted carpet roll 114. As indicated previously, the primary carpet fabric 112 preferably includes a plurality of pile-forming yarns projecting outwardly from one side of a primary base. If the primary carpet 112 used in the present invention is a tufted carpet, its configuration will preferably conform to that of the primary carpet 12 illustrated in regard to the prior art in FIG. 1A, while if the primary carpet 112 used in the present invention is a bonded product, its configuration will preferably be that of the primary carpet 12 illustrated in FIG. 1B.

Alternative embodiments including those disclosed in U.S. Pat. No. 4,576,665 to Machell (incorporated by reference) may likewise be utilized. For example, it is contemplated that specialized primary backings such as nonwoven structures comprising fiberglass sandwiched between layers of polyester may be utilized in the primary tufted carpet to impart the desired properties relating to stability thereby potentially reducing or even eliminating the need for the latex pre-coat presently utilized. Moreover, it is contemplated that if a precoat is to be utilized, it may be added directly in-line in an operation prior to any adhesive operation.

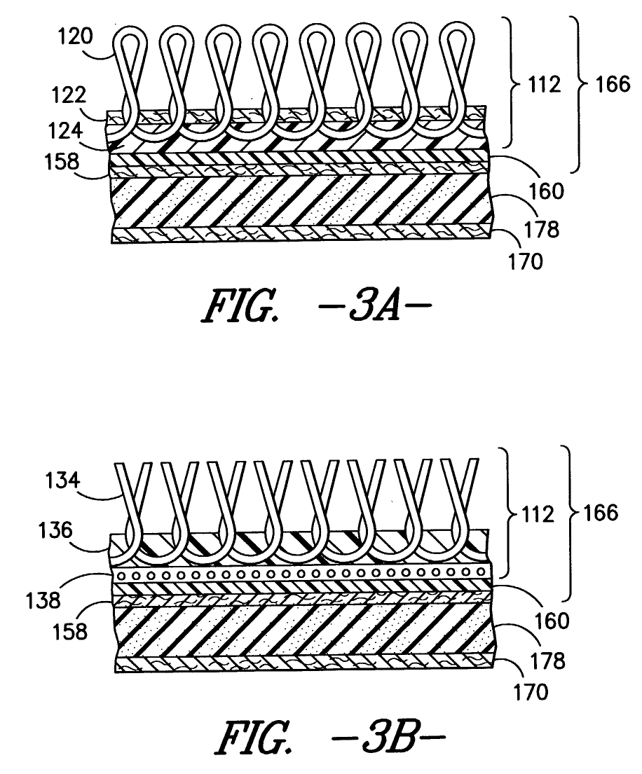

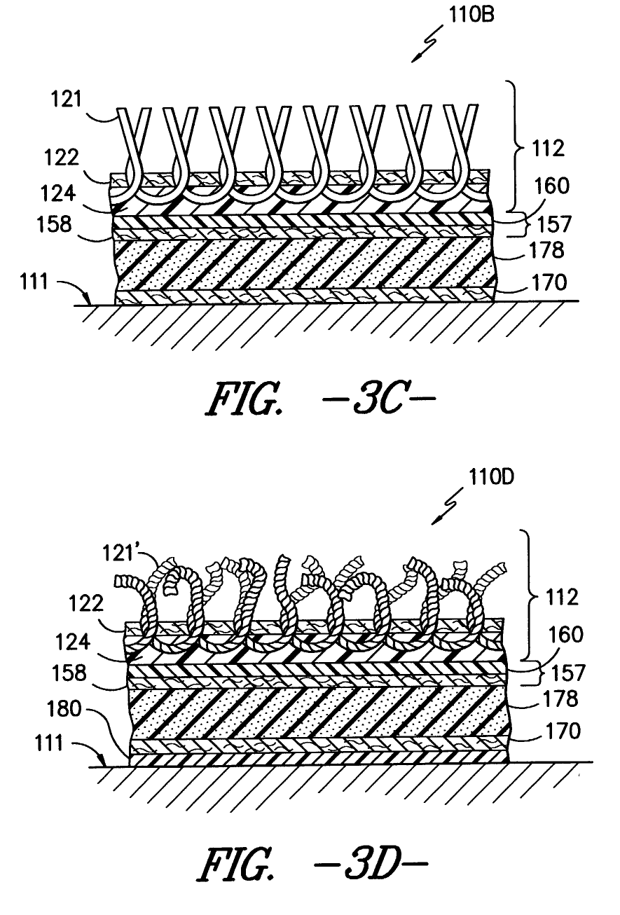

With regard to one preferred embodiment, in the tufted carpet of the present invention (FIG. 3A), the primary carpet fabric 112 preferably comprises a loop (or cut) pile layer 120 of pile-forming yarns tufted into a primary backing 122 as is well known and held in place by a precoat of latex or a hot melt adhesive 124 of a bonding material or adhesive such as latex, a hot melt adhesive or a urethane based adhesive. It is contemplated that the latex or hot melt adhesive may be added in-line after removal from the carpet roll prior to the application of any other adhesive as described below. The carpet may be steamed after addition of the precoat to facilitate subsequent printing operations if desired to reduce stresses. The primary carpet fabric 112 may be steamed and/or heated after addition of the pre-coat layer 124 to facilitate subsequent printing operations, such as direct or indirect jet dying or printing, and/or if desired to reduce stresses. Further, the primary carpet fabric 112 may be printed or dyed prior to addition of the reinforcement material 158 and/or layer of cushioning material or foam 178.

In the bonded carpet of the present invention (FIG. 3B), the primary carpet fabric 112 preferably comprises a plurality of cut pile yarns 134 implanted in a latex or hot melt adhesive 136 which is laminated to a reinforcement or substrate layer 138 of a woven or nonwoven material including fiberglass, nylon, polyester or polypropylene. It is contemplated that this substrate layer 138 may be precoated with latex or other thermoplastic polymers to permit melting adhesion with the cut pile yarns 134 upon the application of heat, thereby potentially reducing or eliminating the need for the latex or hot melt adhesive 136.

The two basic primary backing constructions are woven polypropylene and non-woven polyester. Each material may have a variety of construction characteristics engineered for a specific end use. According to one potentially preferred embodiment, the preferred primary backing material 122 of FIG. 3A is a 5-30 pick per inch, more preferably 10-20 pick per inch, woven polypropylene, with needle punched nylon fleece.

According to another possibly preferred primary backing or tufting substrate embodiment, the primary backing 122 is a fused multi-component structure of a woven layer and a non-woven material needle punched through the woven layer, with at least a portion of the non-woven material being a low melt or binder material which when subjected to calendering (pressure and heat) melts and fuses the non-woven and woven materials to form an enhanced stability primary backing. In accordance with one particular example, the woven layer is a woven polypropylene, the non-woven material is polyester, and the low melt material is low melt or co-polyester. In accordance with one very specific example, a ratio of 30% by weight low melt polyester fiber and 70% by weight polyester fiber is preferred. The weight percent range of low-melt or binder material may range from about 10%-100% by weight of the non-woven, preferably 10%-70%, most preferably 10%-40%. The non-woven material may be any natural or synthetic fiber or blend thereof. For example, the non-woven may be polyester, recycled polyester, polypropylene, stabilized polypropylene, acrylic, nylon (polyamide), bi-component polyester, bi-component nylon, and blends or combinations thereof. If the non-woven material is a polypropylene or stabilized polypropylene, then no additional low melt material is needed.

The low melt material may be any synthetic material or fiber or blend that has a melting point below the calendering temperature and will adhere to the adjacent fibers. For example, the binder or low melt material may be polyester, co-polyester, polypropylene, polypropylene that has been chemically enhanced to raise the melt temperature, bi-component polyester, bi-component nylon, polyethylene, nylon, low melt nylon web, powder binder, chemical binder, extruded polypropylene web, and combinations or blends thereof. The woven material may be any natural or synthetic material or fiber or blend which serves as a tufting base in combination with the non-woven and low melt materials. For example, the woven material may be polypropylene, stabilized polypropylene, flat ribbon yarn (tape) polypropylene, polyester, polyester knitted scrim, polypropylene woven scrim, recycled polyester, and blends or combinations thereof.

In accordance with at least one example, the woven layer or material may have a pick range of from about 6×6 to 30×30, preferably from about 10×10 to 24×22, the non-woven material may have a weight range of about 1-6 oz./sq. yd., with a low melt or binder content of about 10-100% by weight. Such enhanced primary backing materials and production methods are described in U.S. patent application Ser. No. 10/098,053 incorporated by reference herein.

In accordance with a particular exemplary embodiment, an enhanced primary backing having an overall thickness of about 0.017 inches and weight of about 5.03 oz./sq. yd. and a woven polypropylene tape layer (28×11 pick, 24×11 pick, 18×11 pick, or 13×11 pick), a non-woven material of blended, needled, and fused thereto polyester and low-melt polyester fibers (50% by weight natural polyester fibers 2½ denier, 20% black polyester fibers 4 denier, and 30% low melt polyester 3 denier) is formed by placing the non-woven material over the woven layer, needle punching the non-woven material to the woven layer (a small amount of the non-woven goes through the non-woven layer) and then calendering the composite on both sides (at a temperature of about 320□ F. top roller, 280□ F. bottom roller with roller pressures of about 85 psi) to fuse the non-woven material and woven layer. This fused, enhanced stability primary backing is less likely to fray when cut, does not harm the tufting yarn, provides dimensional stability, better tuft lock, and may be used in carpet, broadloom, roll product, carpet tiles, area rugs, mats, and the like.

With regard to another embodiment, in the cut pile tufted carpet construction 110B of the present invention (FIG. 3C), the primary carpet fabric 112 preferably comprises a loop pile layer of pile-forming yarns tufted into a primary backing 122 as is well known and held in place by a pre-coat layer 124 of a bonding material such as latex, a hot melt adhesive or a urethane based adhesive. The pile forming yarns are subjected to a tip shearing or loop cutting operation to yield the cut pile yarns 121 and cut pile construction as shown. It is contemplated that the pre-coat layer 124 may be applied to the primary backing 122 either in a preliminary processing step during formation of the primary carpet fabric 112 or may be added in-line during formation of the cushioned carpet construction in a manner to be described further hereinafter in reference to FIG. 5A. The primary carpet fabric 112 may be steamed and/or heated after addition of the pre-coat layer 124 to facilitate subsequent printing operations, such as direct or indirect jet dying or printing, and/or if desired to reduce stresses.

Referring to at least FIGS. 3C and 3D exemplary potentially preferred constructions of multi-layer surface covering elements for use in overlaying relation to a subfloor 111 are provided. As illustrated, constructions 101B and 101D as may be used in surface covering elements of any of the previously described geometries each incorporate a layered arrangement of a pile forming primary pile fabric 112 in overlying relation to a load distributing layer 157 which in turn is disposed in overlying relation to a layer of cushioning material 178, such as virgin foam, or rebonded foam or compressed particle foam which may include an optional backing layer 170. If desired, the backing layer 170 may also include a friction enhancing coating or chemical treatment 180 (FIG. 3D) as will be described further hereinafter.

The load distributing layer 157 may include a sheet of reinforcement material 158 such as glass or the like in combination with a tie coat material 160 such as a thermoplastic adhesive or thermoset adhesive, preferably a hot melt adhesive or the like to establish a bonding relationship between the primary pile fabric 112 and the cushioning material 178. It is also contemplated that the load-distributing layer may be substantially free of any reinforcement material if desired. That is, the load distribution layer 157 may be formed substantially entirely of one or more layers of tie coat material 160.

It is contemplated that the primary pile fabric 112 may incorporate either a tufted or a bonded configuration (with loop and/or cut pile) as will be well known. It is also contemplated that the primary pile fabric 112 may take on any number of other pile forming constructions including by way of example only and not limitation, textured fabrics having woven, knit, or non-woven constructions.

According to a potentially preferred practice, the primary pile fabric 112 includes a plurality of pile-forming yarns projecting outwardly from one side of a primary base. If the primary pile fabric 112 used in the present invention is a tufted construction as illustrated in FIGS. 3A, 3C and 3D, the primary base is preferably made up of a primary backing 122 and an adhesive pre-coat 124 such as latex or the like. As will be appreciated, the constructions illustrated in FIGS. 3A and 3C are identical except that the pile forming yarns 121 of the embodiment shown in FIG. 13B have undergone a tip shearing or loop cutting operation to yield a cut pile construction. The construction illustrated in FIG. 3D is, in turn, substantially identical to that of FIG. 13C but incorporating pile yarns 121′ of a high twist construction such as a frieze construction or the like which imparts substantial kink to the yarns. As will be described further hereinafter, such yarn constructions may be particularly desirable in residential applications where a deep cushioning feel is desired.

In accordance with a preferred embodiment of the present invention, the carpet yarn 120, 121, 121′ or 134 of carpet products of FIGS. 3A-3D, respectively, is capable of being dyed or printed, such as jet dyed, flood dyed, rotary printed, or the like, by, for example, using a Millitron® jet dye machine marketed by Milliken & Company of LaGrange, Ga., and can either be dyed in broadloom form or in tile form. Also, it is preferred that the complete carpet products or carpet tiles 110A, 110B and 110C of FIGS. 3A-3C are capable of being jet dyed, rotary printed, or the like in broadloom or tile form without destroying the carpet product or tile. For example, the carpet product or tile is preferably capable of withstanding the rigors of a jet dye process including dyeing, steaming, washing, drying, and the like. Consequently, the preferred carpet product or tile can withstand heat and humidity changes, and the yarn can be dyed or printed. For example, the yarn may be white, light colored, such as off white or light beige, yarn dyed, solution dyed, or the like.

In the bonded carpet construction of the present invention (FIG. 3B), the primary carpet fabric 112 preferably comprises a plurality of cut pile yarns 134 implanted in an adhesive 136 such as a latex or hot melt adhesive which is laminated to a reinforcement or substrate layer 138 of a woven or non-woven material including fiberglass, nylon, polyester or polypropylene. It is contemplated that this substrate layer 138 may be pre-coated with latex or other thermoplastic or thermoset materials or polymers to permit melting adhesion with the cut pile yarns 134 upon the application of heat, thereby potentially reducing or eliminating the need for the adhesive 136.

The yarns 120, 121, and 134 may be either spun or filament yarns and are preferably formed from a polyamide polymer such as nylon 6 staple, nylon 6 filament, nylon 6,6 staple, or nylon 6,6 filament, available from companies like DuPont in Wilmington, Del. or Solutia Fibers of St. Louis, Mo., although other suitable natural or synthetic yarns or blends may likewise be employed as will be recognized by those of skill in the art. By way of example only and not limitation, other materials, which might be used, include polyester staple or filament, polyethylene terephthalate (PET, polyester), and polybutylene terephthalate (PBT), polyolefins, such as polyethylene and polypropylene staple or filament, rayon, polyvinyl polymers such as polyacrylonitrile, wool, and blends thereof. A variety of deniers, plies, twist levels, air entanglement, and heatset characteristics can be used to construct the yarn. Potentially preferred materials include nylon 6,6, filament, 1360 denier, 1 ply, no twist, no entanglement, and no heatset; nylon 6,6, staple, 3.15 cotton count, 2 ply, twisted, and heat set; nylon 6,6, mixed filament with a total yarn denier of about 1360; nylon 6,6, mixed filament with a total yarn denier of about 2400; and nylon 6,6, spun fiber with a cotton count of about 1.8 cc, and 2 ply.

Although it is preferred that the yarn (or fiber) be a white or light color to facilitate injection dyeing or printing thereof, it is to be understood that the yarn may be of any nature and color such as solution dyed, naturally colored, and the like, and be adapted for dye injection printing, screen printing, transfer printing, graphics tufting, weaving, knitting, and/or the like.

According to one embodiment, the face weight of the yarn across the carpet will be less than about 10-75 ounces per square yard and will more preferably be 20-45 ounces per square yard and will most preferably be 29-45 ounces per square yard. It is believed that the use of no twist yarn of sufficient denier (in the range of about 1000 d to 1400 d) in non-heatset form may facilitate the achievement of plush coverage even at such relatively low face weights due to bulking which takes place during subsequent dying and steaming operations. This is especially true of the low face weight loop pile construction described in previously mentioned published U.S. patent application 20020034606.

According to another embodiment, the face weight of the yarns across the carpet will be in the range of about 20 to 45 ounces per square yard and will preferably be in the range of about 29 to 45 ounces per square yard.

In accordance with another exemplary embodiment, the primary carpet fabric has a modern residential face such as a frieze cut pile, a saxony cut pile, a loop pile, a Berber loop pile, or the like. This is especially preferred for residential carpet tiles or roll product (carpet tile material in long 3, 6, or 12 foot wide rolls that can be cut to length and/or width).

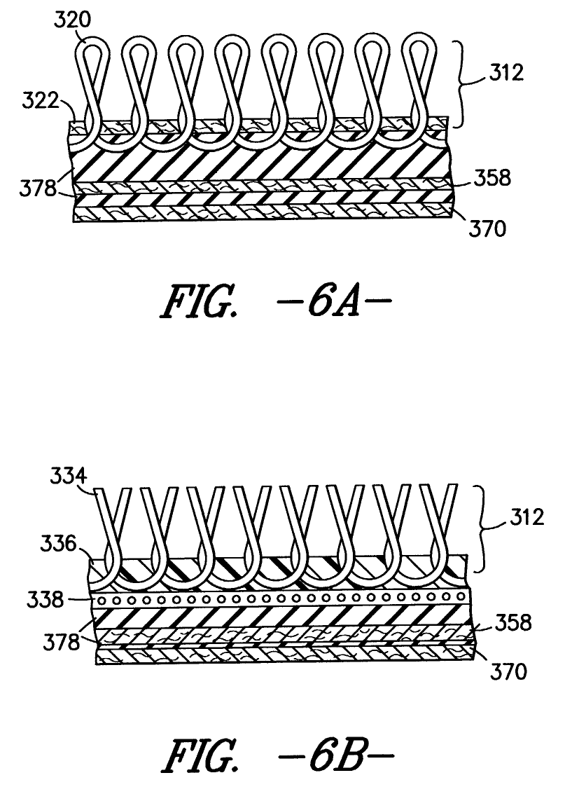

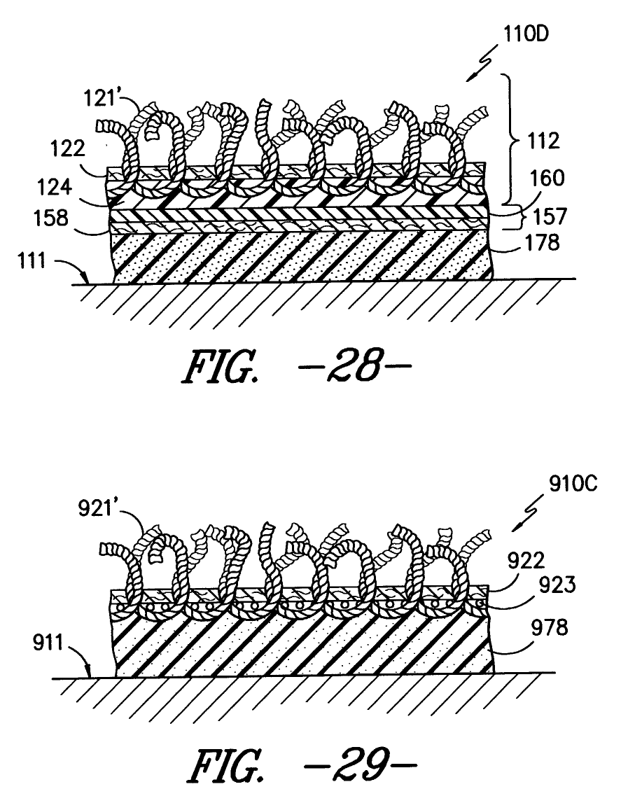

In the tufted product, the adhesive pre-coat 124 is preferably styrene butadiene rubber (SBR) or latex but other suitable materials such as styrene acrylate, polyvinyl chloride (PVC), ethylene vinyl acetate (EVA), acrylic, and hot melt adhesives such as bitumen, polyurethane, polyester, polyamide, EVA, or asphalt based hot melt adhesives or blends thereof may likewise be utilized. As will be described further hereinafter, in the event that a hot melt adhesive is utilized, it is contemplated that a reinforcement material such as a fiberglass, nylon or polyester scrim woven or non-woven can be directly attached to form a composite laminate without the use of additional adhesive layers. Moreover, it is contemplated that the adhesive pre-coat 124 may be entirely eliminated in the tufted product if the loop pile 120 is tufted in suitably stable relation to the primary backing 122 thereby yielding a composite structure as illustrated in FIGS. 6A, 6B, and 27A-27C.

It is contemplated that a carpet construction according to the present invention including either a tufted or a bonded pile forming primary carpet fabric 112 may be adjoined to an underlying sheet, mat or layer of reinforcement material 158 by one or more layers of a resilient polymeric adhesive material 160. The polymeric adhesive material 160 may be of either a thermoplastic or a thermosetting composition. Hot melt materials may be particularly preferred. By way of example only and not limitation, useful hot melts may include bitumen, polyolefin-based thermoplastics. One potentially preferred hot melt material is polyolefin based thermoplastic. Useful thermosetting adhesives may include polyurethanes. It is contemplated that the total mass of hot melt adhesive utilized within both layers adjacent the reinforcement material will preferably be in the range of about 20 to about 100 ounces per square yard of carpet and will more preferably be present at a level of about 35 to about 90 ounces per square yard of fabric.

In accordance with at least one embodiment, it is preferred to add an antibacterial, anti-fungal or anti-microbial agent, such as ALPHASAN™ marketed by Milliken & Company of Spartanburg, S.C., to at least the latex pre-coat layer if not to the latex pre-coat layer and/or to the face yarn, primary backing, tie-coat layer, reinforcement material, foam or cushion, backing, and/or friction enhancing coating or grip layer. ALPHASAN™ is a silver based anti-microbial agent which can withstand heat during processing.

The subfloor may comprise any surface suitable to provide support beneath the surface covering elements 10. By way of example only, materials forming the subfloor 11 may include raised access flooring, plywood, wood particle board, hardwood, concrete, tile, ceramic tile, vinyl or laminate, used carpeting, or the like.

Regardless of the subfloor being covered, it is contemplated that the surface covering elements will preferably provide an aesthetically pleasing coordinated covering in which the juncture between the individual surface covering elements is not substantially discernible to an observer viewing the final installation. That is, individual seams between the surface covering elements are preferably hidden. Moreover, it is desired that the individual surface covering elements should be readily removable after initial placement across the subfloor so as to permit repositioning and/or subsequent replacement as desired. In addition, the surface covering elements preferably should have sufficient internal dimensional stability such that once they are placed across the subfloor they maintain their initial geometry and relative position such that seams do not open up over time. Finally, it is desired that the individual surface covering elements should impart a degree of cushioning across the surface of the subfloor being covered. Such cushioning may be particularly desirable for installations in residential environments where comfort may be at a premium.

It is believed that the ability to hide seams may be enhanced by incorporating a three-dimensional face covering of defined character across the side of the surface covering elements facing away from the subfloor. The geometry of the surface covering elements and the arrangement of the surface covering elements relative to one another across the subfloor may also influence the ability to hide seams.

According to one embodiment, the weight of the yarn within the primary pile fabric will be about 10 ounces per square yard to about 75 ounces per square yard and will more preferably be about 20 ounces per square yard to about 60 ounces per square yard and will most preferably be about 38-39 ounces per square yard.

In accordance with a potentially preferred construction illustrated in FIG. 3D, the primary pile fabric has a face construction such as a frieze cut pile, a saxony cut pile, a loop pile, a Berber loop pile, or the like. A frieze cut pile construction may be potentially preferred. Such constructions provide bulk through the pile due to the fact that the terminal ends of the individual pile yarns are kinked such that the extended length of the yarns actually exceeds the pile height. This bulking gives rise to enhanced compressibility in the thickness dimension of the surface covering element. Such enhanced compressibility is believed to correlate to a generally cushioned feel by a user.

Exemplary and potentially preferred construction features for a pile fabric of tufted construction for use in a surface covering element according to the present invention are provided in the following table.

Primary Pile Fabric Construction

| Pile Parameter | Range | Preferred |
|---|---|---|
| Yarn Denier | 900-3000 | 1180 |
| Yarn Ply | 1-4 | 2 |
| Yarn Twist | 2-9 | 7.5 |
| Yarn Stitch Rate | 6-12/inch | 7.7/inch |
| Gauge | 3/16-5/64 | 1/8 |
| Face Weight | 10-75 oz/yd² | 38 oz/yd² |
| Pile Height | 0.3″-1.5″ | 0.75″ |
| Measured From | | |
| Above Primary | | |
| Backing | | |

As will be appreciated, the desired depth and population density of pile forming yarns across a surface covering element may differ depending upon the intended environment of use. In particular, it is believed that a deeper less populous pile construction may be desired if the surface covering elements are to be used in covering relation to a floor in a residential environment such as a user home. Conversely, shorter pile which is packed closer together may be desired if the surface covering elements are to be used in a commercial environment such as an office, a hospitality environment such as a hotel or an institutional environment such as schools or hospitals.

By way of example only, one potentially preferred cut pile primary pile fabric with a frieze twist formed according to the parameters set forth in the above table for use in surface covering elements for residential applications is characterized by a normal resultant pile depth of about 0.418 inches above the primary backing with a pile length above the primary backing (measured by pulling the yarn to its full extended length) of about 0.6 inches. The mass per unit area of yarn above the primary backing (or other primary base) measured by shaving the yarn across the primary backing and weighing the resultant product is about 29.08 ounces per square yard. Based upon the measured normal depth of 0.418 inches, the standard pile density is about 2,504.5 ounces per cubic yard.

The term “standard pile density” is to be understood to be the ratio of the mass of yarn shaved from the primary backing over a unit area divided by the normal pile depth as represented by the following formula:

$$\frac{m}{p}$$

where:

m is the mass in ounces of yarn over the primary backing in one square yard of primary pile fabric; and

p is the pile height in yards.

Preferably, surface covering elements for use in covering relation to subfloors in a residential environment will be characterized by a standard pile density in the range of about 500 ounces per cubic yard to about 4,200 ounces per cubic yard. More preferably, surface covering elements for use in covering relation to subfloors in a residential environment will be characterized by a standard pile density in the range of about 1500 ounces per cubic yard to about 3500 ounces per cubic yard. Most preferably, surface covering elements for use in covering relation to subfloors in a residential environment will be characterized by a standard pile density in the range of about 2000 ounces per cubic yard to about 3,000 ounces per cubic yard. By way of comparison, a standard pile face for use in a high traffic hotel hospitality environment as sold under the trade designation GRAND PLAZA by Milliken & Company is characterized by a standard pile density of about 4,357.3 ounces per cubic yard.

As will be appreciated, a higher pile height may be desired in a residential environment than in a commercial or hospitality environment. For residential applications it is believed that a normal pile height above any primary backing is preferably in the range of about 0.25 inches to about 0.75 inches and more preferably about 0.3 inches to about 0.5 inches and most preferably about 0.4 inches. In this regard, it is to be understood that by the term “normal pile height” is meant the naturally occurring level of yarn over the primary backing. As illustrated in FIG. 3D, this normal pile height may be less than the actual yarn length due to bending as a result of texturing or twist in the yarn.

As previously indicated, it is contemplated that a surface covering element construction according to the present invention including either a tufted or a bonded primary pile fabric 112 across the surface facing away from the subfloor 111 preferably includes a load distribution layer 157 at a position below the primary pile fabric. By way of example only, it is contemplated that the load distribution layer 157 may include one or more layers of a resilient polymeric tie coat material 160. The polymeric tie coat material 160 may be of either a thermoplastic or a thermosetting composition. Hot melt adhesives may be particularly preferred. By way of example only and not limitation, useful hot melts may include bitumen and polyolefin-based thermoplastics. Useful thermosetting adhesives may include polyurethanes. In the event that the tie coat material 160 is a hot melt adhesive, it is contemplated that the total mass of hot melt adhesive utilized within the load distribution layer 157 will preferably be in the range of about 20 to about 100 ounces per square yard and will more preferably be present at a level of about 35 to about 90 ounces per square yard.

The composition of one potentially preferred hot melt adhesive is set forth in the following table.

Hot Melt Composition

| Component | Percentage |
|---|---|
| Asphalt | 17.6% |
| Stearic Acid | 0.3% |
| Heat Stabilizer | 0.2% |
| Antioxidant | 0.1% |
| Tackifier | 3.0% |
| Amorphous Polypropylene | 4.0% |
| Acid Modified Polypropylene | 2.0% |
| Calcium Carbonate Filler | Remainder |

The physical properties of the hot melt composition from the above table are set forth below.

Hot Melt Properties

| Softening Point | 314-320° F. |
|---|---|
| Cold Flow | 2 to 5 mils per 4 hours |
| Flex Mandrel | 12 to 16 mm at 76 mils |
| CR Viscosity (at 5 sec⁻¹) | 28,000 to 35,000 cps |
| CS Viscosity (at 5O Tau) | 10,000 to 13,000 eps |
| Tensile Strength | ˜450 p.s.i. |
| Elongation at Break | 5.8% |

If desired, a reinforcement material 158 may also be disposed within the load distribution layer 157. In some constructions, the reinforcement material may enhance dimensional stability within the surface covering element to substantially prevent the various layers from undergoing disproportionate dimensional change as the surface covering element is subjected to compressive forces and/or temperature or humidity changes during use and/or processing. One contemplated reinforcement material 158 is a sheet, mat or tissue incorporating multiple fiberglass (glass) fibers entangled in a non-woven construction such as a 2 oz/yd² construction and may be held together by one or more binders such as an acrylic binder or modified acrylic binder. Other materials as may be utilized include woven glass or glass scrim materials as well as woven or non-woven textile materials such as polyester or nylon. If desired, it is also contemplated that the reinforcement material 158 may be eliminated such that the load distribution layer is made up substantially entirely of the tie coat material.

Whether or not a reinforcement material 158 is utilized, the load distribution layer 157 nonetheless acts to disperse concentrated loads laterally through the surface covering element thereby dissipating the applied energy and preventing the structure from being damaged. In operation, the tie coat material 160 acts as a buffer against force concentration and will protect any reinforcement material 158 against puncture or other damage which may arise from point loading. By way of example, the load distribution layer must have sufficient strength and resiliency such that a small diameter shoe heel or other force concentrating object does not puncture the construction.

As indicated, the cushioning material 178 is preferably a foam material. Potentially preferred foam materials may include virgin or prime polyurethane, filled polyurethane, and combinations thereof. Filled polyurethane may be particularly preferred so as to permit the surface covering elements to incorporate a relatively high percentage of recycled filler material.

In accordance with at least one embodiment of the present invention, i [symbol] is preferred to use a foam with a density of about 1 to 25 lbs per cubic foot, more preferably about 3-22 lbs. per cubic foot, still more preferably 5-13 lbs. per cubic foot, and most preferably 6-10 lbs. per cubic foot; a thickness of about 1-30 mm, more preferably about 2-21 mm, and most preferably about 4-12 mm; and, a backing material or backing composite on at least one side thereof.

Referring again to FIG. 2, in the potentially preferred practice the primary carpet fabric 112 is conveyed by means of a plurality of rolls through an accumulator 150 as is well known in the art to a reinforcement bonding unit 155. Simultaneously with the conveyance of the primary carpet fabric 112 to the reinforcement bonding unit 155, a sheet of reinforcement material 158 is likewise conveyed to the reinforcement bonding unit 155. The reinforcement material 158 is preferably fiberglass nonwoven material although alternative materials may include woven glass, woven polyester, nonwoven glass, and nonwoven polyester.

At the reinforcement bonding unit 155, an adhesive 160 (FIGS. 3A-3D) such as a hot melt adhesive is preferably applied to the reinforcement material 158 by means of a film coater or other such unit as are well known. The reinforcement material 158 and the primary carpet fabric 112 are thereafter preferably passed in mating relation between joining members such as rolls 163, 165, thereby bonding the reinforcement material 158 to the underside of the primary carpet fabric 112. That is, the reinforcement material 158 is bonded on the side of the primary carpet fabric 112 from which the pile forming yarns do not project. The bonding of the reinforcement material 158 to the underside of the primary carpet fabric produces a preliminary composite 166 which is thereafter laid into a puddle of a polyurethane-forming composition as described below.

Although the reinforcement bonding unit 155 is illustrated in its preferred embodiment as incorporating a film coater, it is to be understood that alternative equivalent means such as application rolls, spray headers and the like may also be utilized. By way of example only, and not limitation alternative means for the application of adhesive 160 are disclosed in U.S. Pat. No. 4,576,665 to Machell.

In the preferred practice, while the preliminary composite 166 is being formed, a backing material 170 such as a nonwoven backing is passed through a scray 172 to a polymer application unit 175 which preferably includes a polymer discharge unit 176 and a doctor blade 177. The backing material 170 is coated with a polymer 178 such as a polyurethane-forming composition as disclosed more fully below.

In the preferred embodiment, the backing material 170 is an 80% polyester, 20% polypropylene nonwoven fibrous material which is available from Spartan Mills Company in Spartanburg, S.C. While this represents the backing material of preference, it is to be understood that any number of alternative compositions may likewise be utilized as dictated by requirements regarding shrinkage and installation. By way of example only, in instances where very little or no shrinkage may be tolerated, the backing material may be up to 100% polyester. Further, while a nonwoven backing material may be preferred, it is contemplated that either woven or non-woven constructions may be utilized as can materials other than the polyester/polypropylene mix such as nylon, fiberglass and the like. The thickness of the backing material 170 can vary in the range of from about 0.01 inches to about 0.19 inches, although a range of between about 0.05 inches and 0.12 inches may be preferred. Backing layer 170 is preferably a woven or non-woven textile fabric of polyester, polypropylene, polyester/polypropylene, polyester/polypropylene/acrylic, or other appropriate fibers or blends and may contain a colorant, binder, or the like. A non-woven structure of about 80% polyester fiber and about 20% polypropylene fiber, about 50% polyester fiber and about 50% polypropylene fiber, or about 100% polyester fiber may be particularly preferred depending on the face construction of the composite.

Also, a blend of 50% polyester fiber, 20% polypropylene, and 30% acrylic fibers may be used. The polyester, polypropylene and/or acrylic fibers may be of one or more selected colors to give the backing a desired color or appearance. In one embodiment, the foam and backing have a similar color. In a particular example, the foam and/or backing have a green, blue, purple, gray, white, black, brown, or gold color. The color of the backing can be achieved, for example, by using a white polyester fiber and a colored acrylic fiber or by using colored polyester and/or polypropylene fibers. In accordance with another example, an amount of black polyester fibers is blended with an amount of white polyester fibers, an amount of colored polyester fibers, and an amount of white polypropylene fibers to form a non-woven colored backing material or felt having the color of the colored polyester fibers and having a heathered or speckled look. The respective amounts of each type or color of fiber are selected to give the desire a color, brightness, etc.

As indicated, in the preferred practice the polymer application unit 175 applies a deposit of a polymer 178 (FIGS. 3A-3D) to the backing material 170 after which the height of the polymer is doctored to a desired level. In the preferred practice, the polymer applied is a polyurethane-forming composition based on a so called soft segment prepolymer of MDI (diphenylmethane diisocyanate) or an MDI derivative. The polyurethane-forming composition also preferably incorporates a silicone surfactant to improve both the frothability and stability of the polyurethane layer or “puddle” which is spread across the surface of the backing material 170.

The preferred polyurethane-forming composition for use in the present invention is disclosed in U.S. Pat. No. 5,104,693 to Jenkines the teachings of which are incorporated herein by reference. Specifically, the preferred polyurethane-forming composition which is applied across the surface of the carrier backing 170 includes:

(A) At least one isocyanate-reactive material having an average equivalent weight of about 1000 to about 5000;

(B) An effective amount of blowing agent; and

(C) A polyisocyanate in an amount to provide an isocyanate index of between about 90 and about 130, wherein at least 30 percent by weight of such polyisocyanate is a soft segment prepolymer reaction product of a stoichiometric excess of diphenylmethane diisocyanate (MDI) or a derivative thereof and an isocyanate-reactive organic polymer having an equivalent weight of from about 500 to about 5,000 and wherein the prepolymer has an NCO content of about 10 to about 30 percent by weight.

The polyurethane-forming composition also preferably contains a silicone surfactant to improve frothability and stability in the form of an organo-silicone polymer such as are disclosed generally in U.S. Pat. No. 4,022,941 to Prokai et al. the teachings of which are incorporated herein by reference. Specifically, the preferred surfactant is preferably a linear siloxane-polyoxyalkylene (AB) block copolymer and specifically a polyalkyleneoxidemethylsiloxane copolymer. One such silicone surfactant which is particularly useful is available under the trade designation L-5614 from OSi Specialties, Inc. whose business address is believed to be 6525 Corners Parkway, Suite 311, Norcross, Ga. 30092.

A sufficient level of the silicone surfactant is used to stabilize the cells of the foaming reaction mixture until curing occurs to allow the preliminary composite 166 to be laid into the uncured polyurethane-forming composition puddle without destabilizing the layer of such polyurethane-forming composition disposed across the surface of the backing material 170. In general, the silicone surfactants are preferably used in amounts ranging from about 0.01 to about 2 parts per hundred parts by weight of component (A) and more preferably from about 0.35 parts to about 1.0 parts by weight of component (A) and most preferably from about 0.4 to 0.75 parts per hundred parts by weight of component (A).

As previously indicated, after disposition of the polymer across the backing material 170 the layer or “puddle” of polymer deposited is preferably doctored to a pre-determined height by means of a doctor blade located at the polymer application unit 175. While a simple mechanical doctor blade is preferred, alternative equivalent means such as an air knife or the like may also be used. Such an air knife is disclosed, for example, in U.S. Pat. No. 4,512,831 to Tillotson (incorporated by reference).

In one aspect of the present invention, the primary carpet fabric 112 which is preferably joined to reinforcement material 158 to form the preliminary composite 166 can be laid directly into the polyurethane-forming composition immediately after it is doctored to the appropriate level without any need to significantly heat either the preliminary composite 166 or the polyurethane-forming composition. Accordingly, the preliminary composite 166 and the backing material 170 with the applied polyurethane-forming composition may be simultaneously delivered at room temperature to a mating roll 180 immediately following the application and doctoring of the polyurethane-forming composition. As will be appreciated, this avoidance of lag time between formation of the components of the cushioned carpet composite permits highly efficient processing readily controllable either manually or by computer control means (not shown) as are well known to those of skill in the art. In the preferred process, the preliminary composite 166 may be slightly preheated to improve operating control during lamination and curing but such preheat is not essential to formation of the desired product.

In the illustrated and preferred embodiment of the carpet, the process described above results in the layer of reinforcement material 158 being laid adjacent to and at least partially embedded in the layer of polyurethane 178. That is, the reinforcement material 158 is preferably in intimate contact with the polyurethane 178 such that the polymer material will hold the reinforcement in place.

Once the preliminary composite 166 has been laid into the polyurethane-forming composition, the resulting composite may be heated in a heating unit 182 by means of conduction, radiant, or convection heaters as are well known in the art. Contact conduction heaters may be preferred. Such heating may be carried out at a temperature of between about 250° F. and about 325° F. for between about 2 minutes and 8 minutes. The resulting foam cushion layer (FIGS. 3A, 3B) which is produced thereby preferably has a density of between about 3 pounds per cubic foot and about 25 pounds per cubit foot and more preferably between about 5 pounds per cubic foot and about 15 pounds per cubic foot and most preferably between about 6 pounds per cubic foot and about 8 pounds per cubic foot.

Following the heat curing operation, the cushioned carpet composite which is formed may be passed over a unidirectional heat source 185 such as a plate heater or roll heater at about 400° F. to fuse any outstanding fibers on the backing material 170 into a smooth surface. The carpet composite which is formed will thereafter preferably be cut into carpet tiles almost immediately to avoid any undesired cupping or curl.

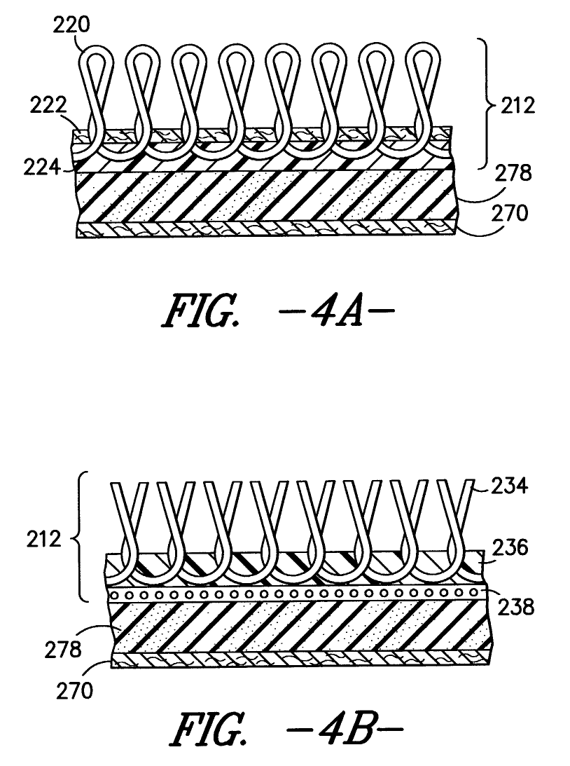

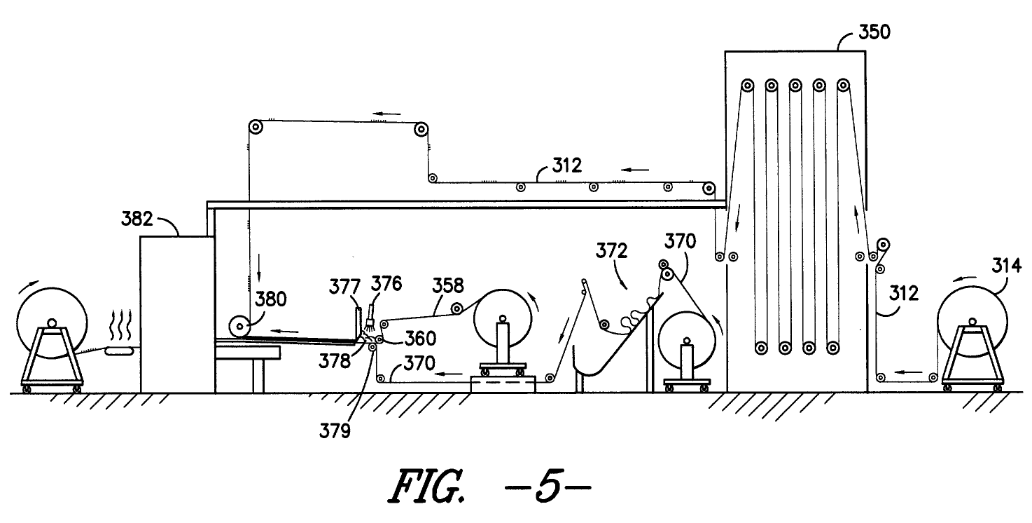

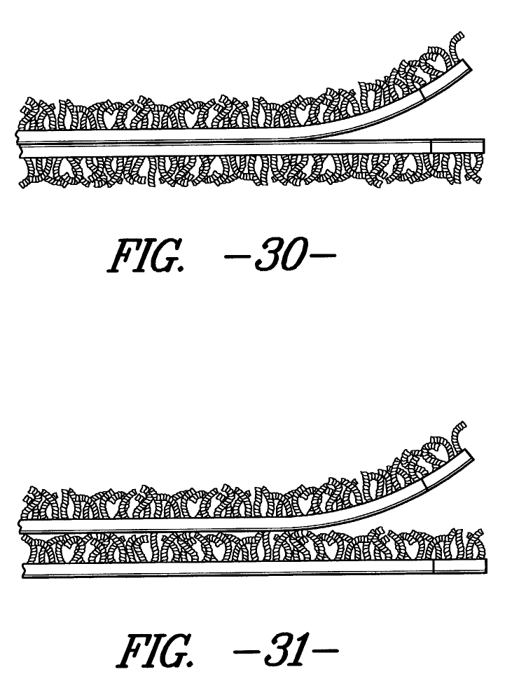

It will be appreciated that a number of alternative practices may be incorporated into the present invention yielding slightly different products. By way of example only, the reinforcement material 158 may be left completely out of the process thereby making the use of the adhesive application apparatus 155 and adhesive 160 completely unnecessary (FIG. 29). In such instances, the primary carpet fabric may be laid directly into the polyurethane-forming composition thereby yielding a composite structure as illustrated in FIGS. 4A, 4B, and 29 with the polyurethane 278 immediately adjacent to the primary carpet fabric 212.

In yet another potential alternative, the backing 170, 270 may have an adhesive quick release backing attached to the face to which the polyurethane-forming composition is not applied. As will be appreciated, such a quick release backing will permit the carpet to be readily installed and removed without damaging the polyurethane cushion 178, 278. Moreover, it is contemplated that in some instances the backing 170, 270 might be completely eliminated such that the polyurethane cushion 178, 278 would directly contact the flooring as disclosed in relation to my U.S. Pat. No. 4,286,003 which is incorporated herein by reference.

An alternative process and apparatus for producing a cushioned carpet composite according to the present invention is shown schematically in FIG. 5. As illustrated, a primary carpet fabric 312 having either a tufted or a bonded configuration is drawn from a mounted carpet roll 314, through an accumulator 350, in the same manner described above. Simultaneously with the delivery of the primary carpet fabric 312 to the mating roll 380, a reinforcement material 358 such as a nonwoven glass is delivered to a polymer contact roll 360 or similar device such as an extrusion coater. The polymer contact roll 360 preferably is in rolling contact with both the surface of the reinforcement material 358 as well as with an accumulation of a polymer 378 such as the polyurethane-forming composition previously described. The polymer contact roll 360 serves to pick tip a portion of the polymer 378 and to pass the polymer over and through the reinforcement material 358.

Simultaneously with the passage of polymer through the reinforcement material 358, a backing material 370 such as the nonwoven polyester/polypropylene described above is preferably passed in adjacent mating relation to the polymer-coated reinforcement material 358 between the polymer contact roll 360 and a backing material mating roll 379. A doctor blade 377 serves to control the depth of the polymer which does not pass through the reinforcement material 358 into contact with the backing material 370. Thus, it is to be appreciated that a polymer sandwich structure is formed preferably comprising a layer of backing material 370, a relatively thin layer of polymer 378 such as polyurethane which has been passed through a layer of reinforcement material 358, and a doctored layer of polyurethane 378 which was not passed through the reinforcement material 358. This polymer sandwich structure can thereafter be passed to the mating roll 380 for joinder with the primary carpet fabric 312 by laying the primary carpet fabric 312 directly into the doctored layer of polyurethane 378 without any precuring operation.

A potentially preferred configuration for a resulting tufted carpet composite is illustrated in FIG. 6A. As illustrated, the reinforcement material 358 will be at least partially surrounded by, and embedded in, the polyurethane 378. As illustrated, it is contemplated that the layer of precoat may be eliminated in the tufted structure since the tufts may be held in place by the polyurethane 378. A potentially preferred configuration for a resulting bonded carpet composite is shown in FIG. 6B.

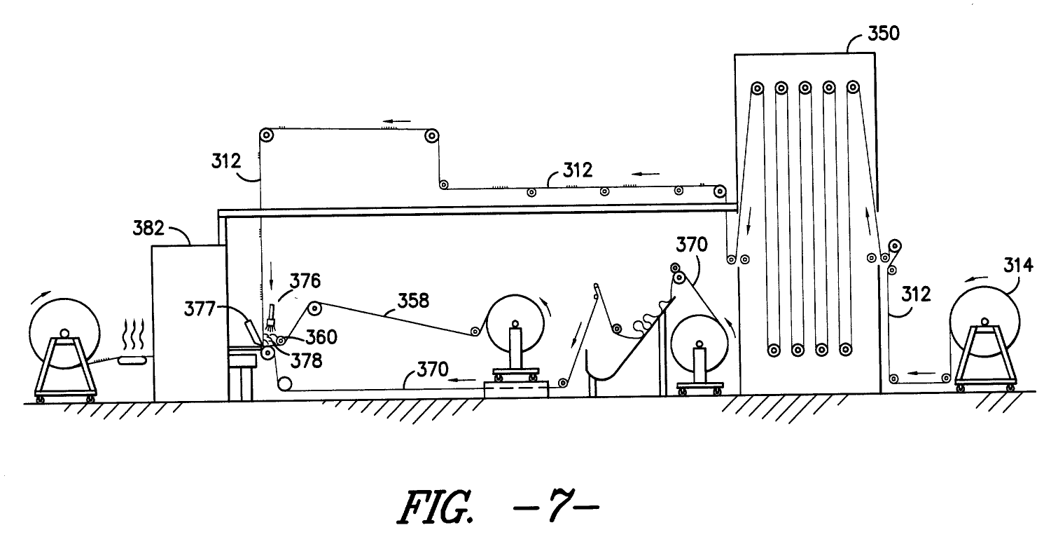

A further alternative process and apparatus for joining all layers of the cushioned carpet composite is illustrated in FIG. 7. As shown, a layer of reinforcement material 358 is preferably passed adjacent to a polymer contact roll 360 which is in simultaneous rolling contact with both the reinforcement material 358 and a deposit of polymer 378. The polymer contact roll 360 serves to spread a portion of the polymer 378 through the reinforcement material 358 to create a coating on both sides thereof. The reinforcement material 358 with its coating of polymer 378 is then joined in a laminate structure to the primary carpet fabric 312 and a layer of backing material 370 by passage through the nip between the doctor blade 377 and backing material mating roll 379. This practice will yield a bonded carpet composite structure substantially similar to those which are illustrated in FIGS. 6A and 6B.

Many techniques have been developed for patterning or coloring substrates, notably absorbent substrates, and particularly textile substrates. With the development of the electronic computer, such techniques have included the use of individually addressable dye applicators, under computer control, that are capable of dispensing a pre-determined, and in some cases, variable, quantity of a dye or liquid colorant to a specifically identified area or pixel on a substrate surface. Such techniques have been disclosed in, for example, U.S. Pat. Nos. 4,116,626, 5,136,520, 6,142,481, and 5,208,592, the teachings of which are hereby incorporated by reference.

In the devices and techniques described in the above-referenced U.S. patents, the pattern is defined in terms of pixels, and individual colorants, or combinations of colorants, are assigned to each pixel in order to impart the desired color to that corresponding pixel or pixel-sized area on the substrate. The application of such colorants to specific pixels is achieved through the use of hundreds of individual dye applicators, mounted along the length of color bars that are positioned across the oath of the moving substrate to be patterned. Each applicator in a given color bar is supplied with colorant from the same colorant reservoir, with different arrays being supplied from different reservoirs, typically containing different colorants. By generating applicator actuation instructions that accommodate the position of the applicator along the length of the color bar and the position of the color bar relative to the position of the target pixel on the moving substrate, any available colorant from any color bar may be applied to any pixel within the pattern area on the substrate, as may be required by the specific pattern being reproduced.

It is contemplated that other arrangements or techniques for systematically applying various colorants to a substrate surface in accordance with pattern data, such as, for example, having one or more sets of colorant applicators that are moved or indexed across the face of a relatively stationary or intermittently indexed substrate, may also employ the teachings herein.

The two basic primary backing constructions are woven polypropylene and non-woven polyester. Each material may have a variety of construction characteristics engineered for a specific end use. According to one potentially preferred embodiment, the preferred primary backing material 122 of FIG. 3A is 20 pick per inch, woven polypropylene, with needle punched nylon fleece.

According to another possibly preferred primary backing or tufting substrate embodiment, the primary backing 122 is a fused multi-component structure of a woven layer and a non-woven material needle punched through the woven layer, with t least a portion of the non-woven material being a low melt or binder material which when subjected to calendering (pressure and heat) melts and fuses the non-woven and woven materials to form an enhanced stability primary backing. In accordance with one particular example, the woven layer is a woven polypropylene, the non-woven material is polyester, and the low melt material is low melt or co-polyester. In accordance with one very specific example, a ratio of 30% by weight low melt polyester fiber and 70% by weight polyester fiber is preferred. The weight percent range of low-melt or binder material may range from about 10%-100% by weight of the non-woven, preferably 10%-70%, most preferably 10%-40%. The non-woven material may be any natural or synthetic fiber or blend thereof. For example, the non-woven may be polyester, recycled polyester, polypropylene, stabilized polypropylene, acrylic, nylon (polyarnide), bi-component polyester, bi-component nylon, and blends or combinations thereof. If the non-woven material is a polypropylene or stabilized polypropylene, then no additional low melt material is needed.

The low melt material may be any synthetic material or fiber or blend that has a melting point below the calendering temperature and will adhere to the adjacent fibers. For example, the binder or low melt material may be polyester, co-polyester, polypropylene, polypropylene that has been chemically enhanced to raise the melt temperature, bi-component polyester, bi-component nylon, polyethylene, nylon, low melt nylon web, powder binder, chemical binder, extruded polypropylene web, and combinations or blends thereof. The woven material may be any natural or synthetic material or fiber or blend which serves as a tufting base in combination with the non-woven and low melt materials. For example, the woven material may be polypropylene, stabilized polypropylene, flat ribbon yarn (tape) polypropylene, polyester, polyester knitted scrim, polypropylene woven scrim, recycled polyester, and blends or combinations thereof.

In accordance with at least one example, the woven layer or material may have a pick range of from about 6×6 to 30×30, preferably from about 10×10 to 24×22, the non-woven material may have a weight range of about 1-6 oz./sq. yd., with a low melt or binder content of about 10-100% by weight. Such enhanced primary backing materials and production methods are described in above-mentioned patent application Ser. No. 10/098,053 incorporated by reference herein.

The reinforcement material 158 preferably serves to enhance dimensional stability across the carpet construction to substantially prevent the various layers from undergoing disproportionate dimensional change as the carpet construction is subjected to compressive forces during use and temperature or humidity changes during use and/or processing. The reinforcement material is preferably a sheet, mat or tissue incorporating multiple fiberglass (glass) fibers entangled in a non-woven construction such as a 0.9-3.5 oz/yd² construction and may be held together by one or more binders such as an acrylic binder or modified acrylic binder. Such a construction is believed to provide dimensional stability and substantially uniform load bearing characteristics in all directions, which may be beneficial in some instances. Other materials as may be utilized include glass scrim materials as well as woven or non-woven textile materials such as polyester or nylon. The reinforcement material 158 along with primary backing 122, and secondary backing 170 provide a carpet product, composite or tile which is stabilized and does not suffer from substantial shrink, growth, stretch, bow, bias, skew, cup, or curl.

Although it is preferred that the carpet construction, roll product, or carpet tile of the present invention be dimensionally stable, it is also preferred that the carpet construction have some flexibility, bendability, or rollability. For example, it is preferred that the carpet tile can bend or flex without breaking as an installer runs a tile up against a wall, bends it in the corner of the floor and wall, and cuts or trims it with a razor knife. Some flexibility not only helps with installation of the tiles or construction, but also allows the product to go around corners, on stairs, up and down inclines, over flooring surface abnormalities, switch plates, wires, cables, and the like. Further, some flexibility or give allows the carpet composite to be rolled as 6′ or 12′ wide attached cushion broadloom (roll product) rather than cut into carpet tiles or prior to being cut into tiles. Still further, some flexibility or give helps keep the tiles from popping out of place if installed without adhesives.

The polymeric adhesive material 160 may be disposed in covering relation on either side of the reinforcement material 158. It is contemplated that such an embedded relation may be achieved by any number of manual or automated techniques. By way of example only, and not limitation, one such technique as may be employed is the direct application of the adhesive material 160 to each side of the reinforcement material 158 preceding insertion between the layer of cushioning or foam 178 and the primary carpet fabric 112. Of course it is contemplated that such application may be conducted by any appropriate means as may be known to those of skill in the art including by way of example only and not limitation, spray coating, dip coating, roll coating, or manual application. However, notwithstanding the actual application mechanism as may be utilized, it is contemplated that the adhesive material 160 will extend in covering relation away from each side of the reinforcement material 158. In this regard, it is contemplated that the adhesive material will preferably perform the dual functions of securing the reinforcement material 158 in place while simultaneously forming a bonding bridge between the underside of the primary carpet fabric 112 and the upper surface of the cushion or foam layer 178.

As previously indicated, due to the relatively porous nature of the reinforcement material 158, it is contemplated that the hot melt adhesive 160 may be pressed through such material. Thus, it is contemplated that the coating station may be replaced with a forced spray, roll or the like if desired to deposit hot melt adhesive 160 across both sides of the reinforcement material 158 prior to lamination.

It will be appreciated that a number of alternative practices may be incorporated into the present invention yielding slightly different products. By way of example only, the reinforcement material may be left completely out of the process thereby making the use of at least one adhesive application apparatus or adhesive layer completely unnecessary. In such instances, the primary carpet fabric may be positioned adjacent the cushion composite (FIG. 29).

In yet another alternative, the cushion backing may have an adhesive quick release backing attached to the face to which the polyurethane-forming composition is not applied (FIG. 3D). Moreover, it is contemplated that in some instances the backing might be completely eliminated such that the cushion would directly contact the flooring (FIG. 29).

Also, the carpet tiles of the present invention are preferably constructed so that they can be installed with little or no adhesive. Such an adhesive-free carpet and method is described for example in U.S. patent application Ser. No. 09/513,020, filed Feb. 25, 2000, and entitled Adhesive-Free Carpet Tiles and Carpet Tile Installations (hereby incorporated by reference herein). Although it is preferred that the carpet composite, product, or construction of the present invention be installed with little or no adhesives, it is contemplated that any conventional installation materials or techniques may be used as well as novel installation materials or techniques of the present invention. For example, adhesives, water based adhesives, releasable adhesives, low VOC adhesives, double sided (double sticky) tape, releasable fastening tape, releasable fastening means such as hook and loop fasteners or systems, and/or the like. It is preferred that the products of the present invention be installed with releasable adhesives, such as PeachPro™ 630 pressure sensitive flooring adhesive sold by The W. W. Henry Company, of Aliquippa, Pa., double sided tape, releasable fastening tape, such as Easy Grip Microplast™ tape for installation of felt backed carpets sold by Gates of Europe, no adhesive, adhesive at doorways, walls, and junctions with other flooring, and the like.

In accordance with another embodiment of the present invention, a releasable adhesive or tack (will release from the floor) is added to the back or base of each tile by a coating process or chemical treatment. In accordance with at least a residential embodiment, it is preferred that the adhesive or tack provide lateral grip with little or no vertical stick and with little or no blocking (tiles can be packaged back to back without permanently sticking together).

Also, it is preferred that the adhesive or tack on the back of the tiles release from the floor, not damage the floor, but still provide lateral grip and possibly some vertical stick. It is preferred that the vertical sticking force be about 0-5 psi and the lateral gripping force be about 0.5-3 psi. The floor or subfloor may be raised access flooring, plywood, wood particle board, hardwood, concrete, tile, ceramic tile, vinyl or laminate, or the like. Such a tack or grip layer on the back of the tile (whether it is foam or felt backed), helps the do-it-yourself installer install the tiles or roll product without additional adhesives. One may add additional adhesive if desired in areas of high traffic, doorways, edges, etc. using conventional adhesives such as spray adhesives, liquid adhesives, tape, etc.

In accordance with at least one example, the tack or grip provides a non-skid surface on the back of the tile to prevent tile movement after installation, when stacked back to back in hot storage conditions, tiles have little adhesion between them, and the tiles can be easily separated without any damage. Further, it provides a low level of adhesion between an installed tile and subfloor to hold down tiles so that installation will not be affected by vacuuming, traffic, and abuses, yet the adhesion force is small enough so that the tile can be easily removed and replaced without any damage to the tile or the subfloor.

In accordance with one particular example, resin materials were applied to the surface of the tile backing at a coating weight of 2 oz/yd2 or less, to obtain a peel strength of 0.4 lb/inch after applying a 0.7 psi vertical load to 2 layers of tile with back-to-back contact. The resin materials are preferably selected from soft (durometer of 60 or less, glass transition temperature of 20 C. or less) organic polymeric resins, such as acrylics, ethylene vinyl acetate polymers, polyurethanes, SBR(styrene-butsdiene rubbers), NBR, chloroprene, natural rubber, EPDM, silicone, and the like. Additionally, a tackifying agent may be added to further increase the coefficient of friction and adhesion of the surface treatment. Examples of tackifying agents includes rosin esters, hydrocarbon resins, phenyol formaldehyde resins, and polyterpene resin. We have found that when the coating weight on the tile is less than about 2 oz/yd2 to provide a peel strength of less than about 0.4 lb/inch, an installed tile will have minimal lateral movement and can be easily removed and replaced without incurring any damage to the tile or the subfloor.

The resin materials can be applied to the back of a tile by coating, spray, impregnation, powder coating, and printing methods. Preferably, the tack or grip material is applied to the surface of the tile backing, by coating methods. Examples of coating methods, include floating knife, slot die coating, transfer roll coating, air knife coating, and curtain coating processes. The resin materials can be applied in the form of water based latex emulsions, dispersions, solvent solutions, hot melt, UV curable liquid, single component and multicomponent reactive liquid resins, and solid powder resins. After application of the coating, a drying and or curing process may be used depending on the form of the resin chosen.

The ASTM D 4518-91 method was used to measure the static friction of tiles surface treated with resin materials. The sled was a 3×3 inch carpet tile and the specimen in the diagram was a clean glass plate. The minimal sliding angle was about 45 degrees or more, preferably, 70 degrees or more. The preferred static friction, or lateral grip, is 0.05-5 psi. More preferably the static friction, or lateral grip, is 0.05-3 psi.

The peel strength was measured by 1) pressing 2 pieces of 3×3 inch tile materials back-to-back under 0.7 Psi pressure; 2) leaving the pressed tiles in a 70 C. oven for 2 days; 3) cooling the pressed tiles to room temperature and measure peel strength using a force gauge. Similarly, a tile is pressed against different subfloor materials and aged at 90 C. for 3 days before cooling to room temperature. The tile is peeled off from the subfloor. The peel force should be 5 psi or less, more preferably, 0 to 2 psi and most preferably, 0.1 to 0.6 psi. The tile and subfloor is then inspected for any damage or residue.

In accordance with one embodiment of a latex backing having lateral grip, little or no vertical stick, no residue left on the floor or subfloor, no permanent blocking to other tiles or flooring, the latex backing also has the benefit of acting as a pressure sensitive adhesive so that during installation, tiles can be slid into place and then pressed down upon to activate the lateral gripping and any vertical stick.

FIG. 8 shows a particular example of a shaped carpet product or tile having a double chevron on each of two opposing sides (preferably the upper and lower edges) and with the remaining two opposing sides being straight and parallel. Such tiles can be installed monolithic, Ashlar, or the like. The double chevrons on opposite sides of the tile are preferably complements of one another (fit with an adjacent or abutting tile) in that on one side the chevrons are external chevrons, stick out or are convex, while on the other side the chevrons are internal chevrons, recessed or concave. In the particular example shown in FIG. 8, the tiles have straight sides of about 17 inches, each chevron has a width of about 9 inches (one-half the tile width) and a depth of about one inch. Hence, the resultant tile has nominal outer dimensions of about 18″×18″. One can make a rectangular tile by either lengthening the straight sides (for example, making them about 23″ or about 35″ long) or by widening the chevrons or adding additional chevrons. In the particular potentially preferred example shown in FIG. 20, the tiles have straight sides of about 22 inches, each chevron has a width of about 11½ inches, and a depth of about 1 inch,

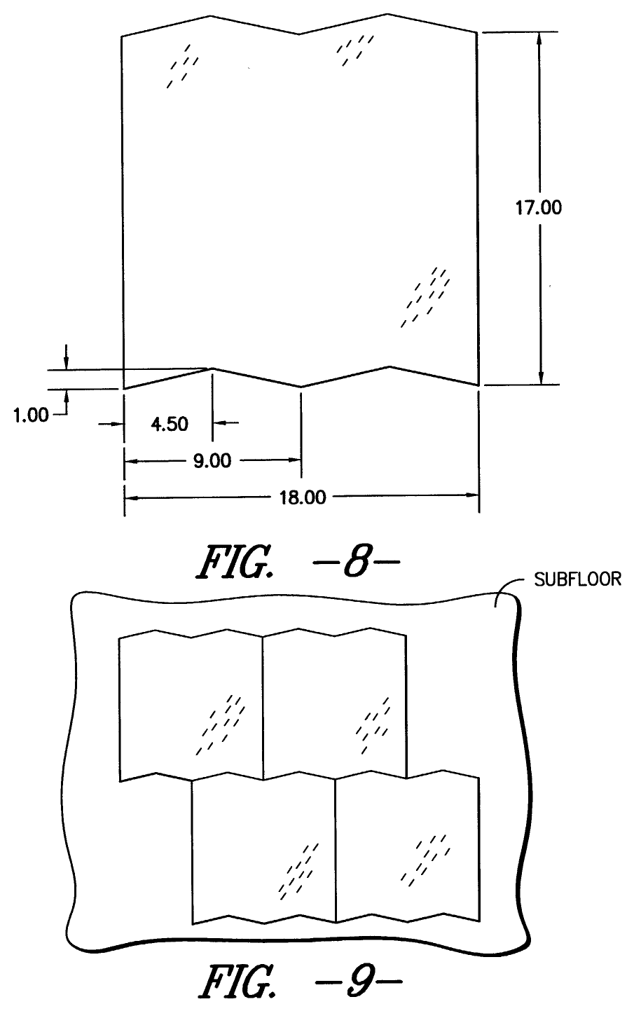

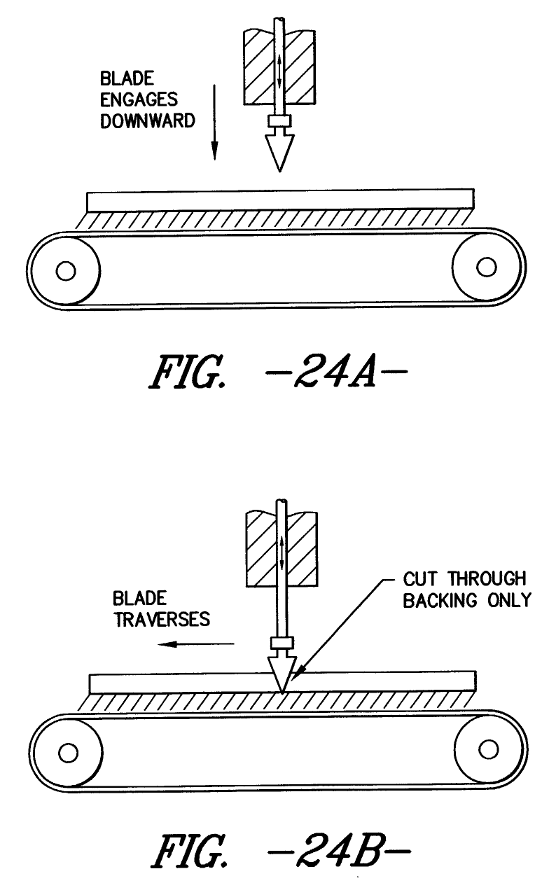

FIGS. 9-19 and 22 show schematic representations of partial carpet tile installations of respective different shaped carpet tiles. Carpet tiles may be installed by starting at the center of the room or by starting along at least one wall of the room or space to be carpeted. FIG. 23 shows a complete installation with edge tiles or cut carpet pieces along the walls or edges of the installation.

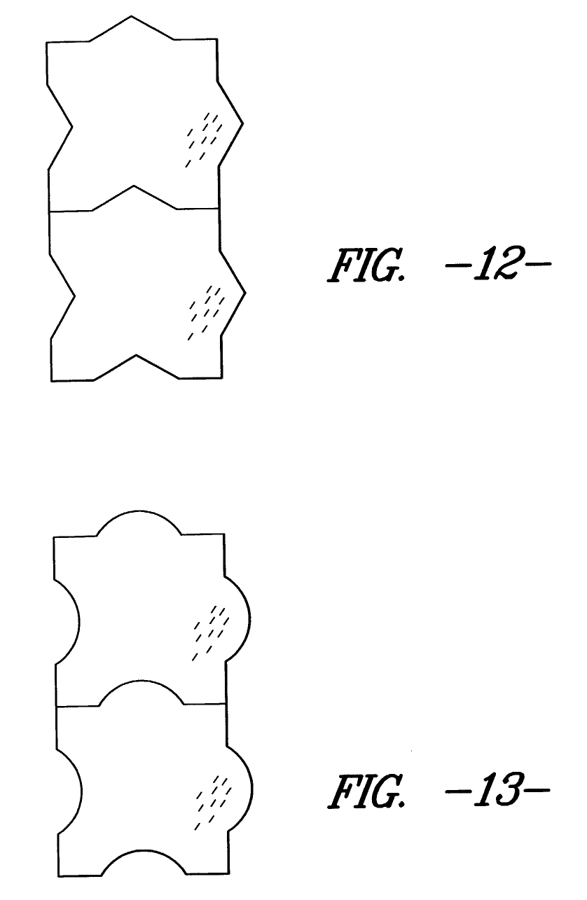

FIGS. 9, 10, 11, 15-18, and 23 show adjacent tiles or rows of tiles being offset. FIGS. 12, 13, 14, 19, and 22 show the tiles being aligned.

FIG. 10 shows rectangular tiles with a single chevron on two opposing sides or ends.

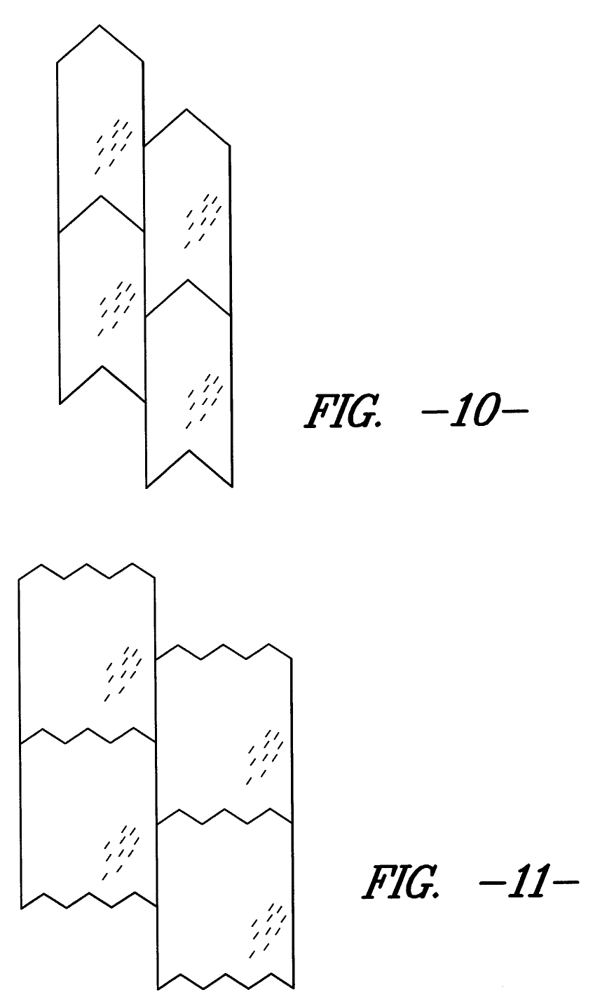

FIG. 11 shows rectangular tiles with multiple (triple) chevrons on two opposing sides or ends.

FIG. 12 shows tiles with a single chevron on four sides thereof. Note that the opposing chevrons are preferably respective external and internal chevrons. Each tile is identical so that adjacent tiles can be fitted together and easily aligned by inserting the external chevron of one tile in the internal chevron of the other. In this way, each tile is identical in shape. If the chevrons on one tile are all external, then an adjacent or abutting tile would need internal chevrons. This would require at least two different tile shapes.

FIG. 13 shows a tile having a single lobe or curved element on four sides thereof.

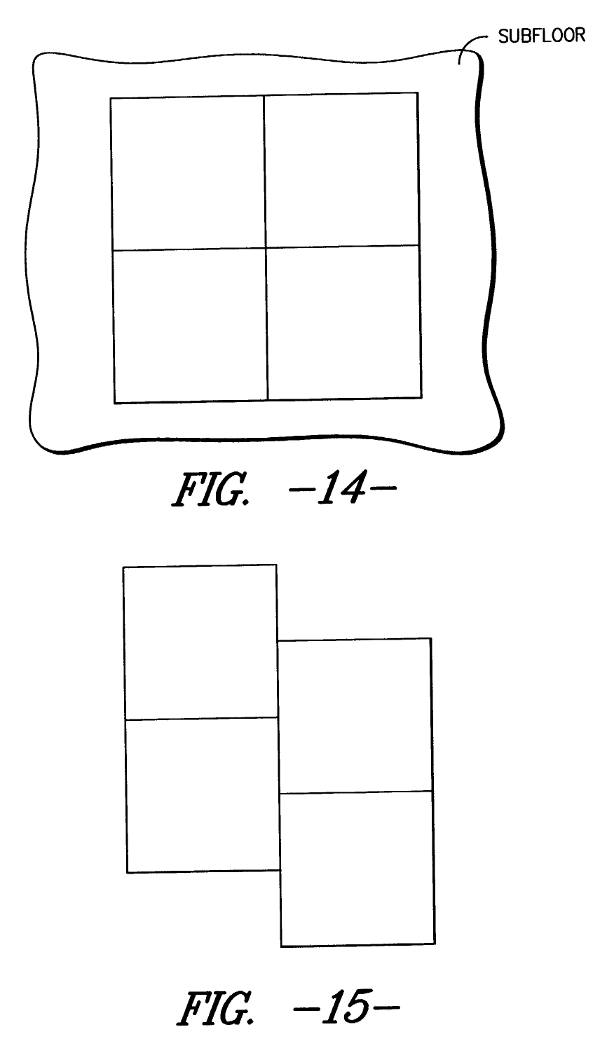

FIG. 14 shows four square tiles each aligned with one another (no offset).

FIG. 15 (like FIG. 9) shows four tiles with two of the tiles being offset with respect to the other two. This offset of adjacent rows or columns of tiles helps break up the seams and reduce the likelihood of noticeable seams.

In some instances, for example, a ceramic tile look or a checkerboard pattern of light and dark tiles, it is desirable to see the seams or different tiles.

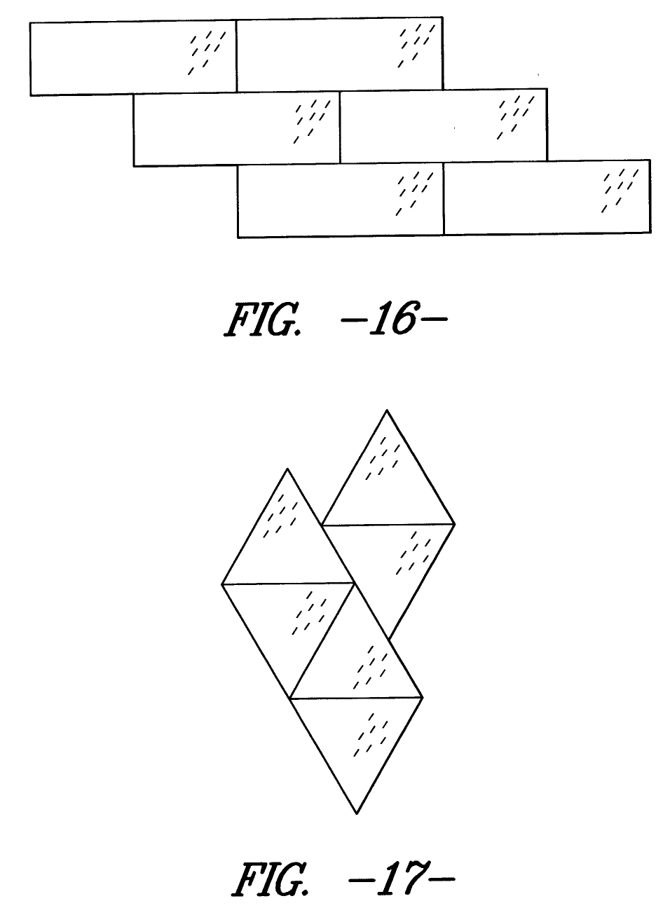

FIG. 16 shows a plurality of rectangular tiles arranged in an offset pattern (similar to that of hardwood flooring).

FIG. 17 shows a plurality of triangular shaped tiles arranged in an offset pattern.

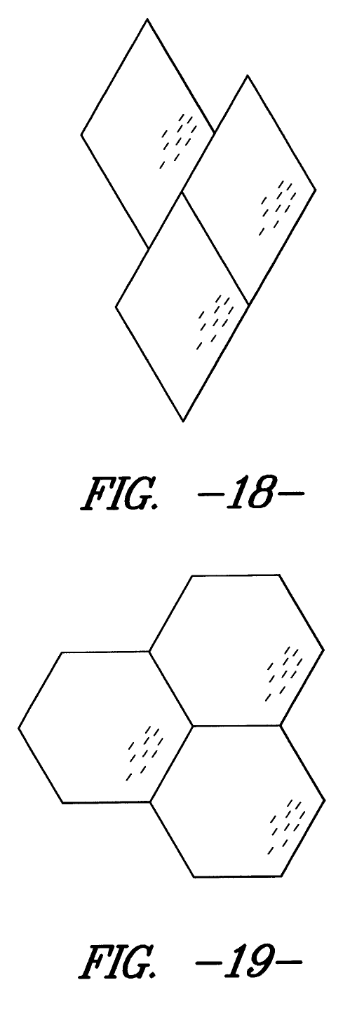

FIG. 18 shows a plurality of diamond shaped tiles arranged in an offset pattern.

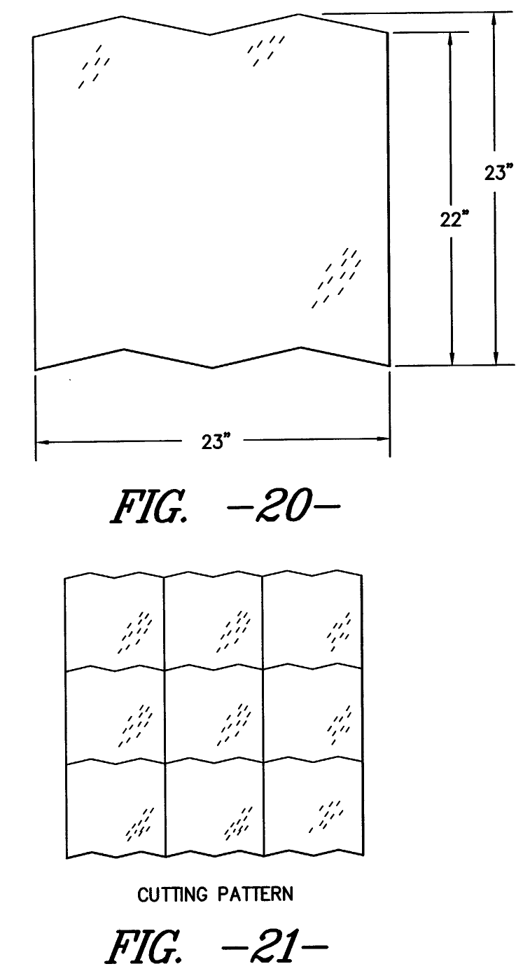

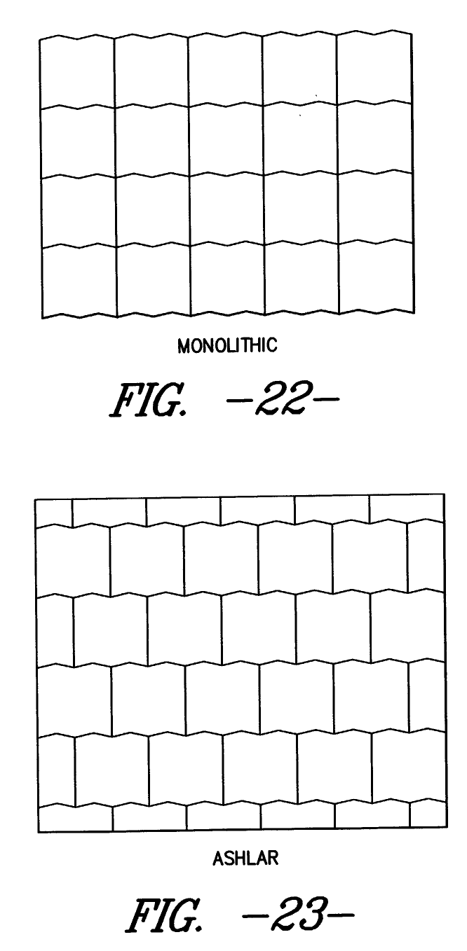

FIG. 19 shows a plurality of hexagonal tiles.

Although certain shapes may be preferred, such as the double chevron shown in FIG. 8, the present invention is not limited to any particular shape of carpet product or tile.

The specifications for preferred forms of such carpet products are described in the tables below:

Preferred Embodiment

| | | |
|---|---|---|
| 1. | Product Name: | Example A |
| 2. | Face: | High Twist Frieze Cut pile |
| 3. | Primary Backing: | Woven polypropylene (PolyBac - 4 oz/yd²) |
| 4. | Total Finished Yarn | 38 oz/yd² |
| | Weight: | |
| 5. | Stitches Per Inch: | 7.81 |
| 6. | Tufting Gauge: | 1/8 |
| 7. | Yarn Polymer: | Nylon 6,6 |
| 8. | Yarn Type: | 1180 filament, with antistat, semi |
| | | dull trilobal, 17 dpf |
| 9. | Yarn Twist: | 7.50 twist per inch in singles (S) and ply (Z) |
| 10. | Yarn Ply: | 2 ply twisted |
| 11. | Heatset: | Yes, @260 to 264 ° F. with steam frieze |
| 12. | Yarn Size: | 3.69/2 cotton count |
| 13. | Tufted Pile Height: | 48/64 inches (314″) |
| 14. | Dyeing Method | Jet Dye, Millitron ® jet dye machine |
| 15. | Precoat Adhesive: | Styrene Butadiene Latex, 12 oz/yd² coating |
| | | weight |
| 16. | Lamination Tiecoat | Hot melt with a bitumen and polypropylene |
| | Adhesive: | resin base, |
| 17. | Tiecoat Coating | 36 oz/yd² |
| | Weight: | |
| 18. | Stabilizing | Fiberglass Mat, 2 oz/yd², modified acrylic |
| | Reinforcement: | binder |
| 19. | Cushion Type: | polyurethane foam |
| 20. | Cushion Thickness | 7 millimeter (prelamination) |
| 21. | Cushion Density | 9 lbs/ft³ |
| 22. | Release Layer | Nonwoven felt |
| | construction: | |
| 23. | Release Layer | 70% polyester/ 30% polypropylene blend |
| | composition | |
| 24. | Release Layer | 4 oz/yd² |
| | weight: | |
| 25. | Modular Shape: | 18″ square, nominal 18″ x 18″ two-side |
| | | double chevron, or 18″ or 24″ wide |
| | | roll product |
| 26. | Modular Size: | 18″ square, nominal 18″ x 18″, |
| | | or 18″ or 24″ wide roll product |
| 27. | Cutting Method: | Controlled Depth cut from the back |
| 28. | Preferred Color | Beige |

B. Residential Tile

Preferred Embodiment

| | | |
|---|---|---|
| 1. | Product Name: | Example B |
| 2. | Face: | High Twist Frieze Cut pile |
| 3. | Primary Backing: | Woven polypropylene (PolyBac - 4 ozlyd²) |
| 4. | Total Finished Yarn | 38 oz/yd² |
| | Weight: | |
| 5. | Stitches Per Inch: | 7.81 |
| 6. | Tufting Gauge: | 1/8 |
| 7. | Yarn Polymer: | Nylon 6,6 |
| 8. | Yarn Type: | 1180 filament, with antistat, semi dull |
| | | trilobal, 17 dpf |
| 9. | Yarn Twist: | 7.50 twist per inch in singles (S) and ply (Z) |
| 10. | Yarn Ply: | 2 ply twisted |
| 11. | Heatset: | Yes, @260 to 264 °F. with steam frieze |
| 12. | Yarn Size: | 3.69/2 cotton count |
| 13. | Tufted Pile Height: | 48/64 inches (3/4″) |
| 14. | Dyeing Method | Jet Dye, Millitron ® jet dye machine |
| 15. | Precoat Adhesive: | Styrene Butadiene Latex, 12 oz/yd² coating |
| | | weight |
| 16. | Lamination Tiecoat | Hot melt with a bitumen and polypropylene |
| | Adhesive: | resin base, |
| 17. | Tiecoat Coating | 46 oz/yd² |
| | Weight: | |
| 18. | Stabilizing | Fiberglass Mat, 2 oz/yd², modified acrylic |
| | Reinforcement: | binder |
| 19. | Cushion Type: | polyurethane foam |
| 20. | Cushion Thickness | 7 millimeter (prelamination) |
| 21. | Cushion Density | 6.3 lbs/ft³ |
| 22. | Release Layer | Nonwoven felt |
| | construction: | |
| 23. | Release Layer | 70% polyester/ 30% polypropylene blend |
| | composition | |
| 24. | Release Layer | 4 oz/yd² |
| | weight: | |
| 25. | Modular Shape: | square, two-side double chevron, or roll |
| | | product |
| 26. | Modular Size: | 23″ square, nominal 23″ x 23″, |
| | | or 23″ wide roll product |
| 27. | Cutting Method: | Controlled Depth cut from the back |
| 38. | Preferred Color | Beige |

C. Residential Tile

Preferred Embodiment

| | | |
|---|---|---|
| 1. | Product Name: | Example C |
| 2. | Face: | High Twist Frieze Cut pile |
| 3. | Primary Backing: | Woven polypropylene (PolyBac - 4 oz/yd²) |
| 4. | Total Finished Yarn | 28-55 oz/yd² |
| | Weight: | |
| 5. | Stitches Per Inch: | 7.3-7.81 |
| 6. | Tufting Gauge: | 1/8 |
| 7. | Yarn Polymer: | Nylon 6,6 |
| 8. | Yarn Type: | 1180 filament, with antistat, semi dull trilobal, |
| | | 17 dpf |
| 9. | Yarn Twist: | 7.50 twist per inch in singles (S) and ply (Z) |
| 10. | Yarn Ply: | 2 ply twisted |
| 11. | Heatset: | Yes, @260 to 264 ° F. with steam frieze |
| 12. | Yarn Size: | 3.69/2 cotton count |
| 13. | Tufted Pile Height: | 48/64 inches (3/4″) |
| 14. | Dyeing Method | Jet Dye, Millitron ® jet dye machine |
| 15. | Precoat Adhesive: | Styrene Butadiene Latex, 12 oz/yd² coating |
| | | weight |
| 16. | Lamination Tiecoat | Hot melt with a bitumen and polypropylene |
| | Adhesive: | resin base, |
| 17. | Tiecoat Coating | 36-46 oz/yd² |
| | Weight: | |
| 18. | Stabilizing | Fiberglass Mat, 2 oz/yd², modified acrylic |
| | Reinforcement: | binder |
| 19. | Cushion Type: | polyurethane foam |
| 20. | Cushion Thickness | 7 millimeter (prelamination) |
| 21. | Cushion Density | 9 lbs/ft³ |
| 22. | Release Layer | Nonwoven felt |
| | construction: | |
| 23. | Release Layer | 70% polyester/ 30% polypropylene blend |
| | composition | |
| 24. | Release Layer | 4 oz/yd² |
| | weight: | |
| 25. | Modular Shape: | square or two-side double chevron |
| 26. | Modular Size: | 24″ square or nominal 24″ x 24″ |
| 27. | Cutting Method: | Controlled Depth cut from the back |
| 28. | Preferred Color | Beige |

D. Residential Tile

Preferred Embodiment

| | | |
|---|---|---|
| 1. | Product Name: | Example D |
| 2. | Face: | High Twist Frieze Cut pile |
| 3. | Primary Backing: | Woven polypropylene (PolyBac - 4 oz/yd²) |
| | | with a heavy |
| | | cap of low melt fibers calendered to bond the |
| | | polypropylene together |
| 4. | Total Finished Yam | 36 oz/yd² |
| | Weight: | |
| 5. | Stitches Per Inch: | 7.3 |
| 6. | Tufting Gauge: | 1/8 |
| 7. | Yam Polymer: | Nylon 6,6 |
| 8. | Yam Type: | 1190 filament, with antistat, semi dull trilobal, |
| | | 17 dpf |
| 9. | Yarn Twist: | 7.50 twist per inch in singles (S) and ply (Z) |
| 10. | Yarn Ply: | 2 ply twisted |
| 11. | Heatset: | Superba, @260 to 264 ° F. with steam frieze |
| 12. | Yarn Size: | 3.69/2 cotton count |
| 13. | Tufted Pile Height: | 48/64 inches (3/4″) |
| 14. | Dyeing Method | Jet Dye, Millitron ® jet dye machine, |
| | | 20 gauge pattern |
| 15. | Precoat Adhesive: | Styrene Butadiene Latex, 12 oz/yd² coating |
| | | weight |
| 16. | Lamination Tiecoat | Hot melt with a bitumen and polypropylene |
| | | resin base, |
| | Adhesive: | |
| 17. | Tiecoat Coating | 36-46 oz/yd² |
| | Weight: | |
| 18. | Stabilizing | Fiberglass Mat, 2 oz/yd², modified acrylic |
| | Reinforcement: | binder |
| 19. | Cushion Type: | polyurethane foam |
| 20. | Cushion Thickness | 7 - 8 millimeter (prelamination) |
| 21. | Cushion Density | 6 lbs/ft³ |
| 22. | Release Layer | Nonwoven felt |
| | construction: | |
| 23. | Release Layer | 100% polyester |
| | composition | |
| 24. | Release Layer | 2.5 oz/yd² |
| | weight: | |
| 25. | Tack Layer | Releasable adhesive (latex, hot melt) |
| 26. | Modular Shape: | square or wave pattern |
| 27. | Modular Size: | 18″-36” |
| 28. | Cutting Method: | Controlled Depth cut from the back |
| 29. | Preferred Install | Ashlar |

E. Residential Tile

Preferred Embodiment

| | | |
|---|---|---|
| 1. | Product Name: | Example E |
| 2. | Face: | High Twist Frieze Cut pile |
| 3. | Primary Backing: | Enhanced backing of woven |
| | | polypropylene with needled |
| | | and calendered polyester and low |
| | | melt polyester |
| 4. | Total Finished Yarn | 38 oz/yd² |
| | Weight: | |
| 5. | Stitches Per Inch: | 7.81 |
| 6. | Tufting Gauge: | 1/8 |
| 7. | Yarn Polymer: | Nylon 6,6 |
| 8. | Yarn Type: | 1180 filament, with antistat, semi dull trilobal, |
| | | 17 dpf |
| 9. | Yarn Twist: | 7.50 twist per inch in singles (S) and ply (Z) |
| 10. | Yarn Ply: | 2 ply twisted |
| 11. | Heatset: | Yes, @ 260 to 264° F. with steam frieze |
| 12. | Yarn Size: | 3.69/2 cotton count |
| 13. | Tufted Pile Height: | 48/64 inches (3/4″) |
| 14. | Dyeing Method | Jet Dye, Millitron ® jet dye machine |
| 15. | Precoat Adhesive: | Styrene Butadiene Latex, 8 oz/yd² coating |
| | | weight |
| 16. | Lamination Tiecoat | Hot melt with a bitumen and polypropylene |
| | Adhesive: | resin base, |
| 17. | Upper Coating | 18-46 oz/yd² |
| | Weight: | |
| 18. | Stabilizing | Fiberglass Mat, 2 oz/yd², modified acrylic |
| | Reinforcement: | binder |
| 19. | Cushion Type: | polyurethane foam |
| 20. | Cushion Thickness | 7-8 millimeter (prelamination) |
| 21. | Cushion Density | 6 lbs/ft³ |
| 22. | Release Layer | Nonwoven felt |
| | construction: | |
| 23. | Release Layer | 70% polyester/ 30% polypropylene blend |
| | composition | |
| 24. | Release Layer | 4 ozlyd² |
| | weight: | |
| 25. | Modular Shape: | 18″ square or nominal 23″ x 23″ two-side |
| | | double chevron |
| 26. | Modular Size: | 18″ square or nominal 23″ x 23″ |
| 27. | Cutting Method: | Controlled Depth cut from the back |
| 28. | Preferred Color | Beige |

A preferred residential type carpet tile can preferably be installed on a residential floor with a seamless or near seamless appearance. There are several factors why seams between the installed tiles can be virtually invisible to an observer in a room.

1. There is preferably equal density of yarn at the tile joint or seam line compared to the interior surface of the tile. In a typical commercial carpet tile, there is lower density at the edges of the tile because yarn is lost in the full depth tile cutting process during manufacturing.

2. This product is preferably cut with controlled depth cutting that cuts through the carpet backing and not through the yarn. Nearly 100% of the yarn is preserved at the cut edge.

3. This product is preferably a cut pile construction that allows controlled depth cutting. A loop pile construction requires a full depth cut to cut all the yarn loops at the tile edge.

4. This product preferably has a lot of yarn that extends past the vertical plane of the tile edge. This yarn over the edge facilitates the easy blending of yarn from adjacent modules across the tile joint. This allows the edge yarn to hide the seams so that the modular units to look nearly seamless immediately after installation.

5. The preferably high twist frieze yarn is the reason the yarn wants to spill over the edge of the vertical tile plane. The liveliness, length, and flexibility of this yarn and density of the carpet pile creates a lateral force that pushes the yarn past the tile edge.

6. A preferably non-linear edge on a non-square shaped tile minimizes the continuous linear segment lengths of a tile joint (especially in the non-process direction). This further breaks up the tile seam line and makes it less noticeable to the human eye.

7. An installation method that offsets the position of the tile into a brick-like or Ashlar pattern also reduces the continuous linear segment length of tile joints.

The preferred residential carpet product is designed to be easy to install. One target market is people who are likely to undertake “do-it-yourself” (D-I-Y) projects in the home environment. Target retailers include department stores, home centers, and hardware stores such as Wal-Mart, Target, K-mart, Lowe, Home Depot, Ace Hardware, etc.

The reasons the preferred residential carpet product is easy to install are:

1. The product is a modular unit that is small enough in size to be easily handled by one person. For example, 18″ square, 18″×24″ rectangle, 24″ square, 36″ square, 18″×36″ rectangle, 24″×36″ rectangle, nominal 18″×19″, 23″×23″, or 24″×24″ two sided single chevron or multiple chevron, nominal 19″×19″ four sided single or multiple chevron, nominal 24″×26″ two sided single or multiple chevron, nominal 26″×26″ four sided single or multiple chevron, 18″ sided right triangle, 24″ sided right triangle, 18″ sided diamond, 24″ sided diamond, nominal 18″×36″ bone shaped, 9″ square border tiles, 6″×9″ rectangular border tiles, 4″×9″ rectangular frame tiles, 24″ wide octagonal tiles, edge tiles which complement the other tiles, and the like. A conventional roll of broadloom carpet is wide (12 foot or more), heavy, awkward, and generally unmanageable for one person.

2. The preferred Two-sided Double Chevron tile shape of the present invention is notched so the tile edges have a definite fit and arrangement. This insures that the tiles are installed with the process direction of each tile aligned. The double chevron or notch allow each row of tiles to be offset by one half the width of a tile. This makes it easy to align the tiles for fast installation.

3. The possible adhesion methods are:

a. Freelay or adhesive free—no adhesion necessary

b. Modular adhesive—a water-based adhesive that is pressure sensitive and prevents the tile from moving in a horizontal direction. Can be used with 100% floor coverage or in a partial floor coverage grid-like application. Also, it can be applied to the back of each tile in full tile coverage or in a pattern.

c. Double-sided tape or releasable fastening tape—Used to secure the tiles to the floor in a partial coverage application.

d. Anchor tile—At least one or several tiles are anchored to the floor with double sided tape or modular adhesive and all other tiles are installed freelay or adhesive free around the anchor tile.

e. Anchor edges—Use double-sided tape or adhesive to adhere tiles at doorways, steps, edge of inlay, around perimeter of room, etc.

Preferred Total Product Construction

Residential Tile Ranges/Alternatives

| | | | Possible | |
|---|---|---|---|---|
| | Preferred Embodiments | | Range | |
| | (A) | (B) | Low | High |
| 1. | Product Name: | Residential Modular Product or System | | |
| 2. | Face: | loop pile, cut & loop pile, tufted cut-pile, | | |
| | | bonded cut-pile, woven, knit, nonwoven, or | | |
| | | textured pile | | |
| 3. | Pick per inch | | 5 | 30 |
| 4. | Primary | Nonwoven polyester, nonwoven polypropylene, | | |
| | Backing: | or woven propylene with nylon needlepunched | | |
| | | cap, woven polypropylene with a polypropylene | | |
| | | cap, woven polypropylene with a polyester cap | | |
| | | and low melt polyester binder | | |
| 5. | Total Finished | oz/yd² | 10 | 75 |
| | Yarn Weight: | | | |
| 6. | Stitches Per | | 5 | 14 |
| | Inch: | | | |
| 7. | Tufting Gauge: | 1/8, 1/10, 5/64 | 5/32 | 1/10 |
| 8. | Yarn Polymer: | Nylon 6,6, Nylon 6, Polyester, Polypropylene, | | |
| | | Wool, or Wool/Nylon blend | | |
| 9. | Yarn Type: | Filament, spun, or staple | 900 | 3000 |
| 10. | Yarn Twist: | | 2 | 9 |
| 11. | Yarn Ply: | Twisted —2 ply, 3—ply, 4 ply, unplied singles | | |
| | | yarn, or air entangled yarn; Cabled —2 ply, 3 | | |
| | | ply or 4 ply | | |
| 12. | Heatset: | Heatset or non heatset yarn; heatset frieze | 250 | 275 |
| | | without steam | | |
| 13. | Yarn Size: | | 2.90/2 | 1.90/2 |
| 14. | Tufted Pile | Inches | 1/8 | 2 |
| | Height: | | | |
| 15. | Dyeing Method | Jet dye, flood dye, yarn dye, space dye, | | |
| | | combination flood dye & jet dye, or beck dye | | |
| | | (may also be printed or graphics tufted) | | |
| 16. | Precoat | Styrene Butadiene Latex, hot melt, ethyl vinyl | 8 | 40 |
| | Adhesive: | acetate, acrylic, polyvinyl chloride, or no | | |
| | | recoat adhesive | | |
| 17. | Lamination | Hot melt with a bitumen and polypropylene | | |
| | Tiecoat | resin base, polypropylene hot melt, bitumen hot | | |
| | Adhesive: | melt, polyethylene hot melt, or polyurethane | | |
| | | styrene butadiene rubber | | |
| 18. | Upper Tiecoat | oz/yd² | 20 | 70 |
| | Coating Weight: | | | |
| 19. | Stabilizing | Fiberglass mat with modified acrylic binder, no | 0.9 | 3.5 |
| | Reinforcement: | reinforcement, fiberglass scrim, polyester scrim, | oz./yd. | oz./yd.² |
| | | or fiberglass mat with urea formaldehyde binder² | | |
| | | or melamine binder | | |
| 20. | Cushion Type: | Polyurethane foam, virgin filled polyurethane foam, prime | | |
| | | polyurethane foam, styrene butadiene rubber foam, | | |
| | | polyethylene foam, or polyvinyl chloride foam | | |
| 21. | Cushion | Millimeters (prelamination) | 1 | 18 |
| | Thickness | | | |
| 22. | Cushion Density | lbs/ft³ | 3 | 25 |
| 23. | Release Layer | Nonwoven or woven | | |
| | construction: | | | |
| 24. | Release Layer | % polyester/ % polypropylene blend | 0%/ | 100%/ |
| | composition | | 100% | 0% |
| 25. | Release Layer | oz/yd² | 1 | 6 |
| | weight: | | | |
| 26. | Tack Layer | Psi | 0.05 | 5 |
| | Lateral Grip | | | |
| 27. | Tack Layer | Psi | 0 | 5 |
| | Vertical Stick | | | |
| 28. | Modular Shape: | square, rectangle, single chevron, two sided | | |
| | | double chevron, four sided double chevron, | | |
| | | hexagon, single chevron, multi-chevron, double | | |
| | | axe head, tomahawk, sine wave edge (double- | | |
| | | sided or four sided), bone, tile, mat, runner, or | | |
| | | rug | | |
| 29. | Modular Size: | Inches per side (or inches of width for roll | 4 | 72 |
| | | product) | | |
| 30. | Cutting Method: | Controlled depth or full depth from front or back | | |
| 31 | Preferred Colors | Solids (Beige, Green, Blue, Gray, Pink, Brown, | | |
| | | Taupe, White, Red), heathers, patterns, designs, | | |
| | | or combinations thereof | | |

A particular preferred residential carpet is defined as denier of 900-3000, preferably 1190; ply of 1-4, preferably 2; twist 2-9, preferably 5-7; stitch rate 6-12, prefer gauge 3/16-5/64, preferably ⅛; face weight, 10-75 oz/yd², preferably 39 oz/yd²; pile height 0.3″-1.5″, preferably 1″.

U.S. Pat. No. 5,929,145 describes bitumen backed carpet tile and bitumen compositions suitable for carpet tile backing and is hereby incorporated by reference.

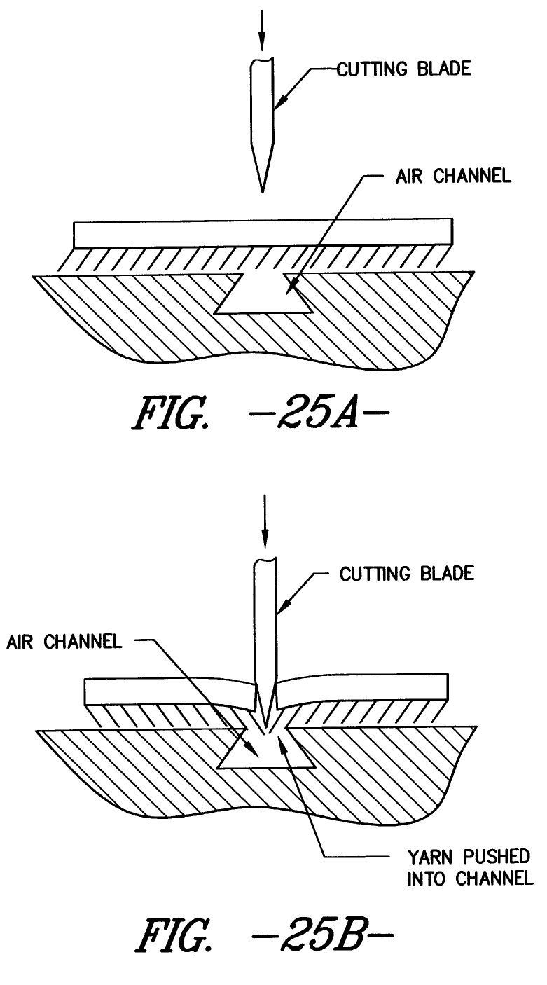

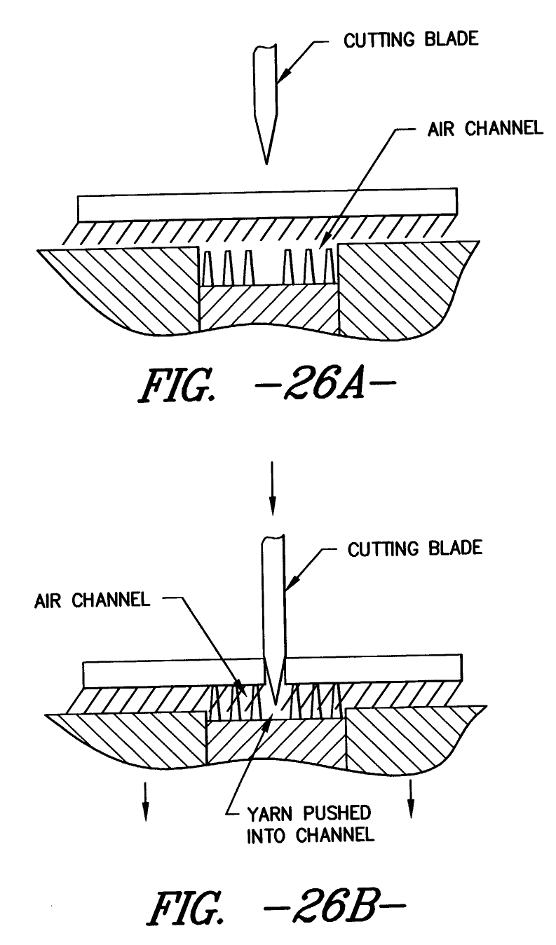

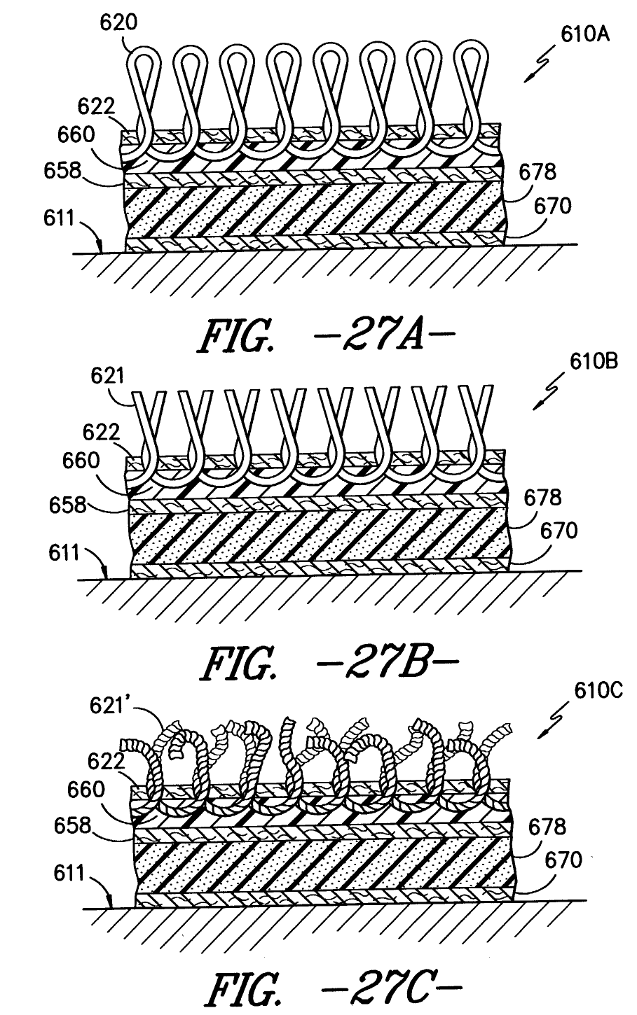

With reference to FIGS. 24A-26B, it is preferred that the cut pile residential tile be stamped or cut from the tile precursor or carpet composite by cutting from the back using, for example, controlled depth ultrasonic cutting (FIGS. 24A, 24B) or controlled depth die cutting (FIGS. 25A, 26B) using an air strike plate that allows the yarns to move out of the way of the blade. The preferred die cut blade is a steel rule die with scalloped or serrated edges. Other forms of cutting such as laser, water jet, rotary reciprocating blade, band saw, and the like may be used.

A particular preferred embodiment of the controlled depth cutting is illustrated in FIGS. 26A and 26B. Vertically reciprocating pins support the carpet while allowing the die to cut through at a controlled depth. The pins improve the cutting quality by supporting the carpet and limiting the number of edge fibers which are inadvertently cut.

As will be appreciated, while polyurethane foam as described above may be preferred, it is contemplated that the material forming the cushioning layer 178 may be the subject of a broad range of alternatives. By way of example only and not limitation, at least six options or examples of foam for use in forming the cushion material 178 are contemplated for forming the surface covering elements.

1. Use of standard filled Polyurethane system as the virgin and/or rebond polyurethane. One contemplated polyurethane foam contains 110 parts of filler and has a density of about 15 lbs/cu. ft. Based upon a thickness in the range of 0.04-0.12 inches, using the density and filler levels above, the weight range of the polymer is about 4.32 oz/sq yd to 12.96 oz/sq yd. The density can be lowered by lowering the amount of filler.

2. Another option which would also work for the virgin and/or rebond polyurethane is to adjust the filler levels to reduce the density to 13 lbs/cu. ft. At the same thickness limits the polymer weights would then be 2.72-8.24 oz/sq. yd.

3. Another option for the virgin and/or rebond polyurethane is to use an unfilled polyurethane (Prime urethane) system. High densities such as above are not possible with prime however, they perform because of the wall structure and the fact that no filler is present. Based upon a prime at 6 lbs/cu. ft. applied at the thickness limits above the polymer weight would be 2.88-8.64 oz/sq. yd.

4. Another option is to use a polyurethane system available under the trade designation KANGAHIDE by Textile Rubber and Chemical Company which has only 15 parts of a filler material and is applied at 6-9 lbs/cu. ft. density may be used. If a polymer calculation is again made at the described thickness limits it would be 4.3-13.02 oz/sq. yd.

5. Another option is to use a medium density or hybrid foam formed of mechanically frothed and chemically blown polyurethane foams. Such a mechanically frothed and chemically blown polyurethane foam is described, for example, in U.S. Pat. No. 6,372,810 hereby incorporated by reference herein.

6. Another option is a polyurethane foam formulation including fly ash as a filler as described for example in U.S. Pat. No. 6,096,401 hereby incorporated by reference herein.

The density of filled prime or virgin polyurethane foams can be controlled by limiting the amount of filler. For example, one can reduce the filler content to produce a prime polyurethane foam of about 6 lb. per cubic foot density.

Although the above examples have to do with polyurethane, a water based foam system can also be used. For example, the foam may be an SBR foam. Although a virgin polyurethane or filled polyurethane foam may be preferred, it is to be understood that rebond polyurethane foam or other compressible particles made from other foams (open cell, closed cell) or materials such as SBR foam, PVC foam, polyethylene foam, cork, rubber, crumb rubber, and/or the like may also be used. In particular, it is contemplated that in place of foam, a felt or non-woven cushion may be utilized.

Regardless of the cushioning material used, it is contemplated that in at least one embodiment such material will preferably be characterized by a compression modulus such that a relatively soft feel is imparted to the user. By way of example only, it is contemplated that the cushioning material will preferably be characterized by a 50% compression at a load of between about 5 and about 70 psi and more preferably about 10 to about 30 psi when the isolated cushioning material is measured according to ASTM specification D3574 Test C (Compression Force Deflection Test).

If desired, the surface covering elements of any of the described constructions may also include an optional friction enhancing coating 180 (FIG. 3D) which may be applied in either a substantially continuous or patterned arrangement. By way of example only and not limitation, such fiction enhancing coatings may include latex, hot melt adhesives, and the like. Also, although it is not preferred, the coating 180 may be covered with a release sheet, layer or film.

As illustrated in FIGS. 27A, 27B and 27C, wherein like components to those previously described are designated by corresponding reference numerals within a 600 series, it is contemplated that tufted loop pile and tufted cut pile constructions 610A and 610B may include a first layer of tie coat material 660 such as hot melt adhesive or the like extending away from the primary backing 622 and into contact with a sheet of reinforcement material 658 such as the non-woven glass or scrim material previously described. Thus, the tie coat material 660 serves the function of securing the tufts 620, 621 in place relative to the primary backing 622 thereby avoiding the need to utilize a separate latex or hot melt pre-coat. Accordingly, a single adhesive layer extends between the upper surface of the reinforcement material 658 and the underside of the primary backing 622. Of course, if desired a fiction enhancing coating as previously described may be disposed across the underside of the backing 670.

As previously indicated, it is contemplated that additional stability may be introduced by incorporating stabilizing elements in intimate relation to the primary backing of a tufted primary pile fabric. An exemplary embodiment incorporating such a configuration is illustrated in FIG. 29 wherein like components to those previously described are designated by corresponding reference numerals within a 900 series. As illustrated therein, tufted cut pile construction 910C includes pile forming yarns 921′ tufted through a primary backing 922 which incorporates therein a primary backing stabilizing layer 923 such as a woven or non-woven material or scrim. The primary backing stabilizing layer 923 may be adjoined to the primary backing 922 by a needling or calendering operation. In addition, point bonding may be achieved between the structures by incorporating heat activated adhesive fibers within the non-woven construction. In the event that a construction incorporating a primary backing stabilizing layer is utilized, it is contemplated that the pre-coat and/or the reinforcement material may be substantially reduced or eliminated entirely if desired due to the stability imparted to the enhanced primary backing 922, 923. If desired, a fiction enhancing coating as previously described may be disposed across the underside of the backing 970.

With reference to FIG. 28 which corresponds to FIG. 3D, still another embodiment is illustrated in which the backing layer or felt or other material 170 of FIG. 3D has been eliminated.

With reference again to FIG. 29, in still yet another embodiment, the pre-coat layer, tie-coat layer, reinforcement layer, and backing layer have been eliminated. The foam layer 978 may be adhered to the primary carpet fabric, for example, by being applied directly thereto in a wet or uncured state and then cured.

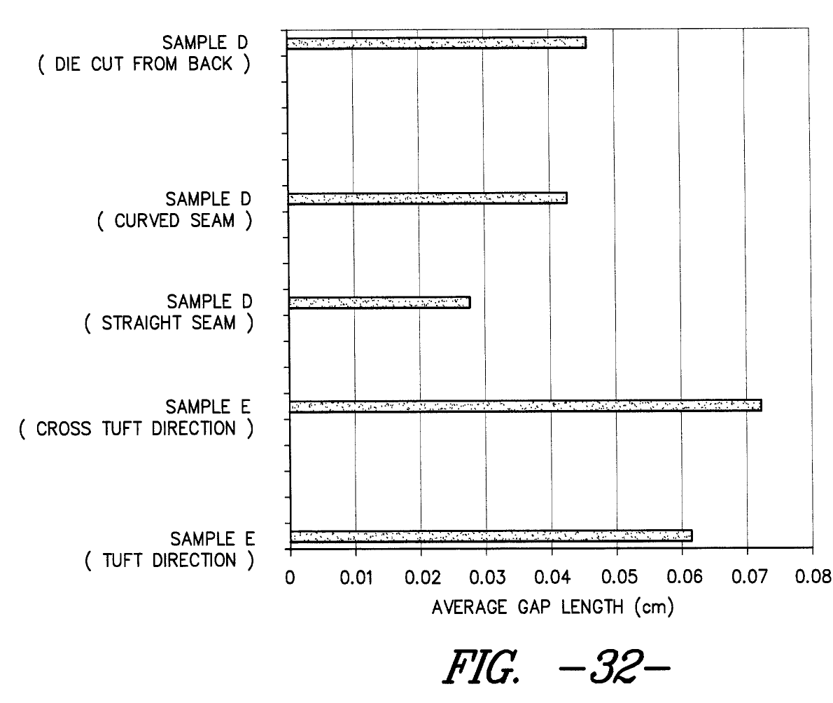

The surface covering elements in the flooring system according to the present invention are preferably suitable for installation in a residential environment by a user with little or no experience with flooring installations. So as to improve the ease of installation, the surface covering elements disposed across the subfloor are preferably resistant to sliding movement across the subfloor once they are placed in position without the need for separately applied adhesives. However, the surface covering elements are preferably readily displaceable vertically away from the subfloor to facilitate replacement or repositioning during installation. As will be appreciated, the ability to lift and move the surface covering element to various positions across the subfloor a number of times without damaging either the surface covering element or the subfloor may be particularly desirable for an unskilled installer. In addition, in a residential environment, the ability to remove and replace or clean a stained or damaged surface covering element at an extended time after installation is desirable. Thus, in accordance with a potentially preferred practice, any friction enhancing coating disposed across the backing is preferably of a character which does not permanently bond to the subfloor. In addition, it is desirable that the friction enhancing coating does not permanently stick to itself so as to avoid undesired blocking attachment in back to back packaging (FIG. 30). Still further, it is desirable that any friction enhancing coating should not adhere to the surface of the primary carpet fabric so as to avoid undesired permanent adhesion if the surface covering elements are stored in roll form or stacked face to back (FIG. 31). That is, the friction enhancing coating preferably provides lateral grip with little or no vertical stick and with little or no blocking to itself or the face of the primary pile fabric.

The evaluation of various friction enhancing coating materials was carried out by conducting sliding friction and blocking tests in accordance with the following procedures.

Friction tests were performed by placing a 3″×3″ piece of coated carpet tile on a smooth flat surface (a piece of laminate wood-like flooring). One end of the flat surface was raised at a rate of ˜10 degrees per second. The center of the carpet tile was always placed 10 inches from the pivot point. The angle at which the carpet tile began to slip was recorded. No weight or pressure was applied to the sample, and both surfaces were visually inspected to be clean before the measurement was performed. Error bars are 5 degrees.

Instantaneous blocking tests were performed by placing two identically coated 3″×3″ carpet tiles back-to-back with a 5 lb weight applied for 1 minute. A strip of aluminum foil was used to mask ½ inch of one edge. The force required to pull the samples apart was measured using an AccuForce III force meter from AMETEK.

Elevated temperature blocking tests at 70 degrees C. (158 degrees F.) were performed by placing two identically coated 3″×3″ carpet tiles back-to-back with a 6.25 lb weight applied for at least 16 hours in a 70 C. oven. A strip of aluminum foil was used to mask ½ inch of one edge. After removing from the oven, samples were allowed to cool. They were pulled apart by pulling on the edge carpet tufts from the masked side of the tiles using an AccuForce III force meter from AMETEK. The peak force needed to separate the tiles was recorded.

Re-Stick friction tests were conducted to determine the reusability of the carpet friction enhancing or grip layer. A 3″×3″ piece of coated carpet was placed on clean, laminate, wood-like flooring with a 5-lb weight applied. After 30 seconds, the weight and carpet were moved to a fresh section of the flooring. This was repeated such that the carpet was exposed to 5 positions. The results of a friction test as described above were then recorded.

Each of the above tests were carried out on samples of carpet tile having a construction substantially as set forth in Example 5 below. The coating in sample 1 was a latex marketed by National Starch & Chemical under the trade designation MULTILOCK 454A. The coating in sample 2 was a latex marketed by Rohm and Haas under the trade designation ROBOND PS-68. The coating in sample 3 was a latex marketed by Air Products and Chemicals under the trade designation AIRFLEX TL12. The coating in sample 5 was a hot melt adhesive marketed by H. B. Fuller under the trade designation HL6102. Control sample 5 was uncoated. The results are set forth in the following table.

| | Dry | Instantaneous | 70 deg C. | Friction on | Re-Stick |
|---|---|---|---|---|---|
| | add-on | Blocking | Blocking | Laminate | Friction |
| Sample | (gsm) | (lbs) | (lbs) | (degrees) | (degrees) |
| 1 | 30 | <0.7 | <0.7 | 85 | 80 |
| 2 | 20 | 0.7 | 1.3 | 48 | 45 |
| 3 | 30 | | 4.8 | 60 | |
| 4 | 20 | <0.7 | 2.7 | 45 | 45 |
| 5 | 0 | <0.7 | <0.7 | 20 | 20 |

Based upon these tests it was concluded that samples 1 and 2 exhibited potentially desirable friction and anti-blocking characteristics with sample 4 being adequate and sample 3 being undesirable. Of course, the samples tested are merely representative and other suitable coating materials no doubt exist. Exemplary materials may include various classes of latex including acrylics, EVA, SBR, and the like and hot melt materials including polyolefins, EVA, SBR, polyamides, and the like . Potentially preferred coating materials may include latex. The dry add-on ranges should preferably be less than about 65 gms per square meter, more preferably less than about 30 grams per square meter and most preferably less than about 20 grams per square meter.

The friction enhancing or grip reducing coatings may be applied to the back of the surface covering elements by various methods including roll coating, spray coating, impregnation, powder coating, and printing methods. After application of the coating, a drying and or curing process may be used depending on the form of the coating chosen.

Although a friction enhancing coating or chemical treatment is preferred, it is contemplated that one may use another releasable adhesive or material such as double sided tape, hook and loop releasable materials, spray adhesives, and the like. As will be appreciated, due to the fact that the surface covering elements in the flooring system of the present invention are intended to support users who walk across the surface, it may be desirable to provide a controlled degree of cushioning within the various components of the surface covering construction to provide a controlled degree of cushioning to the users. It is believed that the cushioning function in the overall construction is derived from both the outwardly projecting yarns within the primary pile fabric 112 as well as from the foam or other cushioning material 178 disposed below the force distribution layer 157. Thus, the pile structure and cushioning material should be characterized by a sufficient deformation under load such that the final resulting desired level of compression is achieved.

As will be appreciated, compressibility character may be evaluated by a standard force deflection test such as set forth at ASTM Standard D-3574 Test C—Compression Force Deflection Test. By way of example only, and not limitation, in order to provide a desired degree of cushioning as may be required in a residential application, it is believed that the overall multi-layer construction 110A-D forming the surface covering element is preferably characterized by a compression modulus such that it is compressed at least 60% when subjected to an applied load of between about 150 to about 1000 psi.

As previously indicated and in accordance with at least one embodiment, there is preferably no visible seam between adjacent surface covering elements once they are installed across the subfloor. It is believed that the ability to reduce the appearance of visible seams may be enhanced by the combination of yarn coloration, surface character and edge cut character of the surface covering elements.

As regards coloration, it is contemplated that the individual surface covering elements may be either patterned or may have a substantially uniform coloration across the surface. In the event that the surface covering elements are intended for residential application, a substantially uniform coloration may be preferred so as to reduce installation complexity. However, it is believed that a heather or mottled coloration may be useful in reducing seam appearance. The application of such heather coloration schemes is disclosed in pending U.S. patent application Ser. Nos. 10/139,019 filed May 3, 2002 and 10/167,185 filed Jun. 11, 2002 the teachings of both of which are incorporated by reference in their entirety as if fully set forth herein.

As regards surface character, the hiding of seams is believed to be a function of both the length of the yarn and the filling character of the yarn along the edge. The filling character of the yarn is, in turn, a function of both the bulk of the yarn as well as the normal density of the yarns disposed along the edge. By the term “normal density” is meant the population density prior to any damage from cutting.

The following table outlines exemplary and potentially preferred construction features for a pile fabric of tufted construction which are believed to provide the desired surface character to hide seams between the various tiles.

As previously noted, the yarns utilized preferably incorporate a substantial degree of twist which adds to the bulk of the yarns due to the kink at the terminal ends of the yarns. As will be appreciated, this kinking gives rise to a phenomenon wherein the naturally occurring pile height is actually less than the extended length of the yarns forming the pile. That is, the individual yarns forming the pile may be pulled straight to extend past the height of the surrounding pile yarns. As indicated previously, this phenomenon lends a substantial cushioning effect to the primary pile fabric. This kink also causes portions of the pile yarns immediately adjacent to the edge of the surface covering element to extend outboard of the edge and to intermingle with complimentary outwardly extending portions of edge yarns on the immediately adjacent surface covering element. In order to provide this cross-over bridging engagement, the yarn within the primary pile fabric is preferably characterized by an extended length above the primary backing in the range of about 0.25 inches or higher and more preferably in the range of about 0.4 to about 1.5 inches and most preferably in the range of about 0.6 inches. In this regard, it is to be understood that by the term “extended length” is meant the length of the yarn above the primary backing when the yarn is pulled straight.

In order to reduce seam appearance, it is also believed to be important to avoid substantial damage of the pile forming yarns in the region immediately adjacent to the edge. That is, the yarns at the edge are preferably not sheared or pulled out of the primary backing during cutting. In order to evaluate the integrity of edges in surface covering elements incorporating pile fabric coverings, the following procedure has been developed.

1. Arrange the element to be analyzed such that the edge of interest can be easily viewed at 9×. The sample must be able to be moved smoothly under the microscope, so as to make a count along a significant length (at least 6 or more inches, for example). Decide upon an appropriate length of edge upon which to make a count. Measure that length and establish the beginning and ending point for the observations to be made.

2. Begin at one end of the distance to be measured and move sequentially from yarn to yarn along that length. Examine each yarn along the length.

3. During examination only consider those yarns that are immediately adjacent to or involved in the actual cut. Yams not at the edge (behind another, for example) are not considered as appropriate to count. Yams that have been cut below the surface (within the adhesion material) and having no protruding filaments are not considered in these counts.

4. Gently move each yarn, as necessary, to determine if any of the filaments that comprise it have been cut. If more than three of the filaments have been completely severed, that yarn is determined to be ‘cut’ yarn and is counted as such.

5. Determine the ‘cut status’ (cut or not cut) for that particular yarn, then move to the next adjacent yarn. Continue until you reach the end of the distance over which you wish to make counts.

6. By dividing the total number of affected (cut) yarns by the measured distance of the edge involved, compute the number cut per unit length for that edge.

Edge character evaluated according to the above method is preferably such that less than about 50 percent of the piles along the edge are cut and more preferably less than about 40% of the piles along the edge are cut and most preferably less than about 25% of the piles along the edge are cut.

In order to prevent edge yarns from being cut, it is contemplated that the individual surface covering elements be stamped or cut from a precursor or composite of larger dimensions by controlled depth cutting from the back using, for example, controlled depth die cutting (FIGS. 26A, 26B) using a displaceable strike plate 61 that extends during cutting (FIG. 26B) such that a plurality of supporting pin elements define the supporting surface surrounding the cut edge during the cutting operation. The preferred die cut blade is a steel rule die with scalloped or serrated edges. Other forms of cutting such as laser, water jet, rotary reciprocating blade, band saw, and the like may be used.

By using a dye cutting procedure as illustrated in FIGS. 24A-26B, it has been found that the percentage of cut piles in the vicinity immediately adjacent the edge of the resulting segmented material can be dramatically reduced. By way of example only, the following table sets forth the results of an analysis of exemplary tufted pile material controlled depth cut from behind in comparison to similar tufted pile materials cut completely through from the face. The analysis was carried out using the procedure as outlined above.

Cut Pile Evaluation

| | End Cuts | | | | | |
|---|---|---|---|---|---|---|
| | Cross Tufting | | | | | |
| | Direction | | | | | |
| | Total | | | Total | | |
| | Counted | Total Cut | | Counted | Total Cut | |
| | End 1* | End 1* | | End 2** | End 2** | |
| Front Cut | 137 | 114 | 83.2% | 93 | 18 | 19.4% |
| Sample A | | | | | | |
| Front Cut | 141 | 92 | 65.2% | 111 | 23 | 20.7% |
| Sample B | | | | | | |
| Back Cut | 99 | 19 | 19.2% | 95 | 15 | 15.8% |
| Sample A | | | | | | |
| Back Cut | 99 | 23 | 23.2% | 102 | 14 | 13.7% |
| Sample B | | | | | | |

*End with yams bent towards edge.
**End with yams bent away from edge.

Thus, by incorporating controlled depth rear cutting that cuts through the primary backing but not the face yarns, tuft damage adjacent to the edge may be substantially reduced to about 25% or less on at least one or more sides or edges.

While various potentially preferred constructions have been illustrated and described, it is contemplated that a wide range of alternatives may exist within the scope of the present invention. By way of example only, and not limitation, the following table details various contemplated variants for each component in a surface covering composite as previously described.

| | (A) | (B) | Possible Range | |
|---|---|---|---|---|
| 1. | Product Type: | Residential Modular Product | Low | High |
| 2. | Face: | loop pile, cut & loop pile, | | |
| | | tufted cut-pile, bonded | | |
| | | cut-pile, woven, knit, | | |
| | | nonwoven, or textured pile | | |
| 3. | Primary | Nonwoven polyester, non- | | |
| | Backing: | woven polypropylene, or | | |
| | | woven propylene with nylon | | |
| | | needlepunched cap, woven | | |
| | | polypropylene with a | | |
| | | polypropylene cap, woven | | |
| | | polypropylene with a | | |
| | | polyester cap and low melt | | |
| | | polyester binder | | |
| 4. | Total Finished | oz/yd² | 12 | 70 |
| | Yam Weight: | | | |
| 5. | Stitches Per | | 5 | 14 |
| | Inch: | | | |
| 6. | Tufting Gauge: | 1/8, 1/10, 5/64 | 5/32 | 1/10 |
| 7. | Yarn Polymer: | Nylon 6,6, Nylon 6, | | |
| | | Polyester, Polypropylene, | | |
| | | Wool, or Wool/Nylon blend | | |
| 8. | Yarn Type: | Filament, spun, or staple | 900 | 2800 |
| 9. | Yarn Twist: | | 3 | 8 |
| 10. | Yarn Ply: | Twisted - 2 ply, 3-ply, 4 ply, | | |
| | | unplied singles yarn, or air | | |
| | | entangled yarn; Cabled - 2 | | |
| | | ply, 3 ply or 4 ply | | |
| 11. | Heatset: | Heatset or non heatset yarn; | 250 | 275 |
| | | heatset frieze without steam | | |
| 12. | Yarn Size: | | 2.90/2 | 1.90/2 |
| 13. | Tufted Pile | Inches | 1/8 | 2 |
| | Height: | | | |
| 14. | Dyeing Method | Jet dye, flood dye, yarn dye, | | |
| | | space dye, combination flood | | |
| | | dye & jet dye, or beck dye | | |
| | | (may also be printed or | | |
| | | graphics tufted) | | |
| 15. | Precoat | Styrene Butadiene Latex, hot | 8 | 40 |
| | Adhesive: | melt, ethyl vinyl acetate, | | |
| | | acrylic, polyvinyl chloride, or | | |
| | | no precoat adhesive (may | | |
| | | include anti-microbial agent) | | |
| 16. | Lamination | Hotmelt with a bitumen and | | |
| | Tiecoat | polypropyleneresin base, | | |
| | Adhesive: | polypropylene hot melt, | | |
| | | bitumen hot melt, | | |
| | | polyethylene hot melt, or | | |
| | | polyurethane styrene | | |
| | | butadiene rubber | | |
| 17. | Upper Tiecoat | oz/yd² | 20 | 70 |
| | Coating Weight: | | | |
| 18. | Stabilizing | Fiberglass mat with modified | 0.9 | 3.5 |
| | Reinforcement: | acrylic binder, no | oz./yd.² | oz./yd.² |
| | | reinforcement, fiberglass | | |
| | | scrim, polyester scrim, | | |
| | | or fiberglass mat with urea | | |
| | | formaldehyde binder or | | |
| | | melamine binder | | |
| 19. | Lower Tiecoat | oz/yd^{2 (or flame lamination)} | 0 | 35 |
| | Coating Weight: | | | |
| 20. | Cushion Type: | Rebond polyurethane foam, virgin filled | | |
| | | polyurethane foam, prime polyurethane foam, | | |
| | | styrene butadiene rubber foam, polyethylene | | |
| | | foam, polyvinyl chloride foam, or nonwoven | | |
| | | felt | | |
| 21. | Cushion | Millimeters (prelamination) | 1 | 18 |
| | Thickness | | | |
| 22. | Cushion Density | lbs/ft³ | 5 | 25 |
| 23. | Release Layer | Nonwoven or woven | | |
| | construction: | | | |
| 24. | Release Layer | % polyester/% polypropylene | 0%/ | 100%/ |
| | composition | blend | 100% | 0% |
| 25. | Release Layer | oz/yd² | 1 | 6 |
| | weight: | | | |
| 26. | Modular Shape: | square, rectangle, single | | |
| | | chevron, two sided double | | |
| | | chevron, four sided double | | |
| | | chevron, hexagon, single | | |
| | | chevron, multi-chevron, | | |
| | | double axe head, tomahawk, | | |
| | | sine wave edge (double-sided | | |
| | | or four sided), bone, etc. | | |
| 27. | Modular Size: | Inches per side (or inches of | 4 | 72 |
| | | width for roll product) | | |
| 28. | Cutting Method: | Controlled depth or full depth | | |
| 29. | Preferred Colors | Solids (Beige, Green, Blue, | | |
| | | Gray, Pink, Brown, Taupe, | | |
| | | White, Red), heathers, | | |
| | | patterns, designs, or | | |
| | | combinations thereof | | |

### COMPARATIVE EXAMPLES 6-17

In the following comparative examples samples tested were as follows:

| Sample | |
|---|---|
| Designation | Material |
| A | Residential carpet tile prototype built by Applicants with |
| | pinstripe surface texturing tufted at 10.48 stitches per inch |
| | with a yarn weight of 38.39 ounces per square yard. The |
| | primary pile fabric is adjoined to a high density prime |
| | urethane foam having a density of 16 lbs per cubic foot |
| | by a layer of hot melt adhesive with a 2 ounce layer of |
| | glass reinforcement material between the hot melt and the |
| | foam. A felt backing is as described in Example 5 below is |
| | disposed across the underside of the foam. |
| B | A residential carpet tile prototype built by Applicants with a |
| | construction identical to sample “A” but with a standard |
| | cut pile face of off-white color. |
| C | Residential carpet tile prototype built by Applicants having |
| | a cut pile tufted construction of 8.68 stitches per inch with |
| | a yarn weight of 22.79 ounces per square yard and a deep |
| | golden speckled surface coloration. The primary pile fabric |
| | was adjoined to an underlying cushion with felt backing as |
| | in sample “A” including hot melt and glass reinforcement. |
| D | A potentially preferred residential carpet tile with rebond |
| | cushion corresponding substantially to the specification is |
| | set forth in Example 5 above. |
| E | Commercially available carpet tile sold under the trade |
| | designation GRAND PLAZA by Milliken & Company. |
| F | Commercially available broadloom carpet sold under the |
| | trade designation PATTERN MATES by Milliken & |
| | Company and having a face weight of 38 ounces per square |
| | yard. |
| G | Commercially available broadloom carpet sold under the |
| | trade designation PATTERN MATES by Milliken & |
| | Company and having a face weight of 55 ounces per square |
| | yard. |
| H | Broadloom carpet having attached cushion of prime |
| | urethane and a scrim backing marketed under the trade |
| | designation BUCKSKIN by Cherokee Carpet Industries. |
| I | Carpet having a nylon cut pile face tufted at 9.33 stitches |
| | per inch at a pile height of 0.64 inches with a pile weight of |
| | 36 ounces per square yard. This product is marketed under |
| | style number SP120 by Mohawk Industries, Inc. |
| J | Carpet marketed by Philadelphia Carpets under the trade |
| | designation CALM 12 having a face weight of 30 ounces |
| | per square yard and a tufted pile height of 0.375 inches. |
| K | Loop pile carpet marketed by Mohawk Industries under |
| | style number SP117 having a pile height of 0.160 inches |
| | with 5.0 stitches per inch and a certified pile weight of |
| | 26.00 ounces. |
| L | Loop pile carpet product marketed under the trade |
| | designation ROAD RUNNER by Milliken & Company |
| M | Bonded carpet product marketed under the trade |
| | designation WHITE WATER by Milliken & Company. |
| N | Carpet tile having a textured loop surface and a felted |
| | backing. |
| O | Bonded pile surface carpet tile having a pile height of 0.245 |
| | inches and finished pile weight of 28 ounces per square |
| | yard marketed under the trade designation COLOR |
| | ACCENTS by Milliken & Company. |

### EXAMPLE 5

| | (A) | (B) |
|---|---|---|
| 1. | Product Type: | Residential Modular Floor Covering |
| 2. | Face: | High Twist Frieze Cut pile |
| 3. | Primary Backing: | Enhanced backing of woven |
| | | polypropylene with needled and |
| | | calendered polyester and low melt |
| | | polyester |
| 4. | Total Finished Yam | 39 oz/yd² |
| | Weight: | |
| 5. | Stitches Per Inch: | 7.69 |
| 6. | Tufting Gauge: | 1/8 |
| 7. | Yarn Polymer: | Nylon 6, 6 |
| 8. | Yarn Type: | 1180 filament, with antistat, semi dull |
| | | trilobal, 17 dpf |
| 9. | Yarn Twist: | 7.50 twist per inch in singles (S) and |
| | | ply (Z) |
| 10. | Yarn Ply: | 2 ply twisted |
| 11. | Heatset: | Yes, @ 260 to 264° F with steam frieze |
| 12. | Yarn Size: | 3.69/2 cotton count |
| 13. | Tufted Pile Height: | 48/64 inches (3/4″ ) |
| 14. | Dyeing Method | Jet Dye |
| 15. | Precoat Adhesive: | Styrene Butadiene Latex, 8 oz/yd² |
| | | coating weight |
| 16. | Lamination Tiecoat | Hotmelt with a bitumen and polypropylene |
| | Adhesive: | resin base, |
| 17. | Tiecoat Coating Weight: | 46 oz/yd² |
| 18. | Stabilizing | Fiberglass Mat, 2 oz/yd², modified |
| | Reinforcement: | acrylic binder |
| 19. | Flame Lamination | Fiberglass mat flame laminated to foam |
| 20. | Cushion Type: | Rebond polyurethane foam, 15 millimeter |
| | | uncompressed chip size |
| 21. | Cushion Thickness | 7-8 millimeter (prelamination) |
| 22. | Cushion Density | 6 lbs/ft³ |
| 23. | Flame Lamination | Felt flame laminated to foam |
| 24. | Release Layer | Nonwoven felt |
| | construction: | |
| 25. | Release Layer | 70% polyester/ 30% polypropylene blend |
| | composition | |
| 26. | Release Layer weight: | 4 oz/yd² |
| 27. | Modular Shape: | 18″ square or nominal 23″ x 23″ two-side |
| | | double chevron |
| 28. | Modular Size: | 18″ square or nominal 23″ x 23″ |
| 29. | Cutting Method: | Controlled Depth cut from the back |

### COMPARATIVE EXAMPLE 6

The compression of the face only for various samples was tested using ASTM specification D3574 Test C (Compression Force Deflection Test) modified to measure 60% compression at reading. The results are tabulated below.

| Sample | Compression modulus (psi) |
|---|---|
| I | 12.802 |
| A | 87.968 |
| B | 125.267 |
| J | 148.987 |
| G | 190.794 |
| L | 251.773 |
| H | 326.901 |
| E | 354.99 |
| F | 500.864 |
| C | 608.977 |
| K | 753.888 |
| M | 1063.683 |
| O | 1149.635 |

### COMPARATIVE EXAMPLE 7

| Sample | Compression modulus (psi) |
|---|---|
| D | 261.408 |
| H | 280.936 |
| A | 285.452 |
| B | 368.239 |
| L | 602.084 |
| C | 777.584 |
| N | 1066.748 |
| O | 1146.429 |
| E | 1515.57 |
| M | 2121.788 |

### COMPARATIVE EXAMPLE 8

The procedure of Example 6 was repeated except that force was measured at 50% compression. The tested portion of the sample consisted only of the foam pad, fiberglass reinforcing layer and hot melt tie-coat layer.

| Sample | Compression modulus (psi) |
|---|---|
| D | 23.444 |
| B | 32.672 |
| C | 33.635 |
| A | 36.252 |
| E | 72.074 |
| N | 73.987 |

### COMPARATIVE EXAMPLE 9

The procedures of Example 6 were repeated in all respects except that force was measured at 50% compression.

| Sample | Compression modulus (psi) |
|---|---|
| Cushion only from sample “D” | 13.389 |
| 4 lb rebond foam underlay from Mohawk | 11.285 |
| Industries | |
| 6 lb rebond foam underlay from Mohawk | 12.405 |
| Industries | |
| 8 lb rebond foam underlay from Mohawk | 51.052 |
| Industries | |

### COMPARATIVE EXAMPLE 10

Compression recovery was measured for various samples. A constant force of 200 pounds was applied to the test specimen. Two complete cycles of loading and relief were applied and the load modulus for each cycle was recorded. The average percentage change of the sample between the first cycle and the second cycle is reported based on the following formula.

(Height at valley − Height at peak) second cycle
(Height at valley − Height at peak) first cycle

| Sample | Recovery % |
|---|---|
| D | 63.5 |
| C | 68.2 |
| H | 70.1 |
| B | 72.3 |
| A | 72.4 |
| E | 80.5 |
| O | 81.7 |

### COMPARATIVE EXAMPLE 11

Planar dimensional stability of various samples was tested by loading a two inch wide strip in a tensile tester and measuring percent elongation.

| Sample | % elongation |
|---|---|
| | (100 lbs force) |
| D | 5.6 |
| H | 13.9 |
| O | 2.4 |

### COMPARATIVE EXAMPLE 12

This example procedure provides for a measurement of resistance to deformations that would cause a carpet tile to go from square to trapezoidal, for instance, due to a shear force on one side of the carpet. The measurement data were collected using a Sintech 1/s mechanical tester controlled by MTS's Testworks 4 software. As the sample is subjected to a shearing force, the force required to shear versus displacement of one end of the sample is measured. More specifically,

1. The setup includes two hydraulic jaws with a gap of 2.5 inches between then laterally. One jaw is fixed and the other is attached to the movable head of the Sintech mechanical tester. A 500-pound load cell was used on the movable head.

2. 2×8 inch strips of carpet are cut using a die. The carpet sample is loaded with the long direction horizontal. The gap between the hydraulic jaws is 2.5 inches so that 5.5 inches of the carpet sample is firmly held (symmetrically) by the two hydraulic jaws on either side of the sample.

3. The two hydraulic jaws are originally set at the same height (with a gap of 2.5 inches laterally between them). The movable jaw cycles from the same height as the fixed jaw through a displacement of 0.5 inch, first higher than the stationary jaw, and then lower than the stationary jaw, and then returns to its starting point. This defines a single cycle of deformation.

4. As the shear deformation cycle progresses, the force versus displacement cycle is recorded. The data shows a hysteretic behavior.

5. To measure the initial shear modulus of the carpet, the slope of the shear force versus shear displacement is calculated for the data from 0-0.08 inch displacement. The resulting initial modulus data are not normalized by the dimensions of the sample.

6. To calculate the Energy (or work) dissipated during the deformation cycle, the area between the forward and reverse shear deformation curves (the curves are hysteretic) is calculated. The resulting energy dissipated data are not normalized by the dimensions of the sample.

The results are set forth in the following table.

| Sample | Initial modulus | Energy |
|---|---|---|
| | (lbF/in) | (lbF * in) |
| H | 9.73 | 1.39 |
| D | 181.02 | 15.55 |
| E | 294.73 | 20.35 |

### COMPARATIVE EXAMPLE 13

The ability of various samples to abut across a flooring surface without seam visibility was evaluated as a function of a developed index referred to as a Seamability Index.

The Seamability Index is defined by the mathematic visibility of the seam in a digital image of the seam. The RGB digital images were captured using a Javelin Electronics Chromachip II model JE3462RGB camera in manual mode. The lighting used was fluorescent room lights. Illumination was set through the iris on the lens. The RGB histogram of the image was checked in Adobe Photoshop 6.0 to make sure none of the pixels were clipped at 0 or 255 (8 bit data storage). The camera was placed 33 inches above the sample and captured 480×640 pixel resolution images that spanned roughly 8.5×11.5 inches. The carpet seam was aligned within the image to go parallel to one of the edges of the image so that line averaging could be done across the whole image in one direction. For seams that are not linear, Adobe Photoshop 6.0 was used to piecemeal cut the image and paste the seams together in a line. The seam shape can be marked within the image by placing a marker in the shape of the seam parallel to the seam.

To prepare the images, two identical tiles were used. The two tiles were seamed in every possible configuration with the tile tufting direction oriented in the same direction. To put the seam in a known configuration, the seam was brushed perpendicularly to the seam with a light hand brushing in a single direction.

The seam is made difficult to identify because of the hiding action of overhanging tufts, printed patterns, three dimensional texturing, etc. To quantify a seam, the deviations due to the seam in the image from the average color value of the base carpet must be quantified. Because there are variations in the image of the carpet that occur regardless of a seam simply due to the bright and shadow points of the tufts (or loops) in the carpet, or other patterns, printing, etc., there are at least two types of variability in the image of a carpet seam. The standard deviation of the color differences from the average color value in the absence of a seam is used to characterize the variability intrinsic to the carpet (in the absence of a seam). Because the tufts, loops, printing, or physical texture of the carpet causes very rapid changes in the digital image pixel values within a small neighborhood, data averaging is utilized to obtain data with a large signal (seam) to noise (base carpet variability) value. The Seamability calculation is based on data averaged over 8 inches in a single direction along a line parallel to the seam. This analysis is generally applicable to carpet substrates where the carpet base is one color or where the texture or printing has the tendency to average to a uniform background over the 8 inch sampling interval used in this test protocol.

The RGB image files are converted to Adobe Lab space within Adobe Photoshop 6.0. The L, a, and b pixel intensity data are each individually averaged in the image in a direction parallel to the seam for a distance of 8 inches to create a line profile of the average intensity in each channel. This brings out the seam information relative to the texture. From this line profile, the average value of L, a, and b for the carpet can be calculated by averaging along the line profile all of the pixel values (except at the seam). The deviation from the average value along the line can be calculated so that one has (L-L_{avg}), (a-a_{avg}), and (b-b_{avg}) line data. The (L-L_{avg}), (a-a_{avg}), and (b-b_{avg}) line data are then combined using a color difference formula:

ΔE (color difference)=((L-L_{avg})²+(a-a_{avg})²+(b-b_{avg})²)^{1/2}.

The standard deviation of the delta E of the carpet texture, (sigma) is next calculated from the delta E line spectra (except in the region of the line that reflects the seam. Then, the point along the delta E line with the maximum deviation (delta E) from the average is found. The value of delta E is recorded. Then the ratio of the maximum deviation (delta E) to the standard deviation (sigma) is calculated as a measure of whether a seam is present or not. The value delta E/sigma also gives a numeric quality measure to the seam. Because of the way that a standard deviation is defined, a Seamability index of 3 or less is probably just the base carpet (95% chance). This would mean that there is no seam present. A large Seamability Index indicates that there is probably a seam present. The larger the Index is, the more noticeable the seam is. The data analysis was performed in Image Pro Plus 4.5. The data was averaged in a line using a standard line-averaging tool. The standard deviation (sigma) and maximum deviation (delta E) were calculated from the line profile using macros written in-house using Image Pro Plus macro language.

The results are tabulated in the following table.

| | Average | | | | |
|---|---|---|---|---|---|
| | Seam | | | | |
| Sample | Index | Seam 1 | Seam 2 | Seam 3 | Seam 4 |
| A | 3.50 | 3.06 | 4.87 | 3.04 | 3.02 |
| B | 7.36 | 4.13 | 12.78 | 5.72 | 6.82 |
| C | 6.74 | 4.45 | 8.36 | 3.52 | 10.64 |
| D (Dark | 2.95 | 3.02 | 2.82 | 3.33 | 2.62 |
| Green) | | | | | |
| D (Beige) | 3.92 | 4.84 | 4.12 | 3.16 | 3.56 |
| D (Light | 2.70 | 3.10 | 2.37 | 2.40 | 2.93 |
| Blue) | | | | | |
| N | 3.98 | | 2.30 | 5.64 | 2.36 |
| O | 6.72 | 8.52 | 2.96 | 7.75 | 7.65 |

### COMPARATIVE EXAMPLE 14

A measurement of relative tuft overlay along the perimeter of various samples was conducted.

For purposes of this example, “Tuft Overlay” is defined as the area produced by tufted yarns exceeding an invisible plane created by the outer edges, perpendicular to the carpet tile backing, enabling the measurability through electronic image capture and computer image analysis.

Sample Prep:

1. Brush the tufted face with an 8-inch medium bristled brush applying moderate pressure perpendicular to the perimeter edge as to maximize tuft overlay.

Image Capture:

2. Place carpet tile (tufted face up) onto the glass scanner bed utilizing the full length of scanning surface.

3. Use Umax's Magic Scan software using default settings to capture scanned images.

4. All samples are scanned using 200 dpi and saved as True Color RGB tif images

5. Use Adobe Photoshop version 6.0 Software to convert images to Lab color space and to split an image into three images each representing one axis in Lab color space.

6. The three newly saved images a then opened using Image Pro Plus version 4.5 image analysis software.

7. The images are rotated as to display the edge horizontally on the monitor.

8. The channel image with the most pixel image data in relation to the area of interest (the tuft overlay region) is then threshold automatically based on detected area size maximum and minimum parameters and gray level values.

9. The detected isolated area is then measured to determine area size and then divided by the width (longest aspect of image—represents carpet tile resulting in the average tuft overlay distance in millimeters along the length of the scanned carpet tile edge.

The results for each of four sides of a representative carpet tile are set forth in the following table.

Tuft Overlay

| | | Avg Overhang along side | Avg Overhang per |
|---|---|---|---|
| Sample # | Side | (mm) | Tile (mm) |
| D | 1* | 9.48 | |
| | 2 | 2.49 | |
| | 3 | 6.10 | |
| | 4 | 3.28 | 5.34 |
| A | 1* | 2.11 | |
| | 2 | 4.57 | |
| | 3 | 0.45 | |
| | 4 | 5.14 | 3.07 |
| B | 1* | 0.08 | |
| | 2 | 3.21 | |
| | 3 | 3.05 | |
| | 4 | 4.19 | 2.63 |
| C | 1* | 0.00 | |
| | 2 | 0.58 | |
| | 3 | 0.70 | |
| | 4 | 0.31 | 0.40 |
| N | 1* | 0.40 | |
| | 2 | 0.23 | |
| | 3 | 0.14 | |
| | 4 | 0.65 | 0.35 |
| E | 1* | 2.39 | |
| | 2 | 4.53 | |
| | 3 | 4.62 | |
| | 4 | 5.51 | 4.26 |

### COMPARATIVE EXAMPLE 15

As procedure was developed to assess the quality (the straightness of the cut through the carpet composite) as well as the “true-ness” of the shape of the cut on a side.

1. Samples are prepared by using a die cutter to cut representative pieces from a carpet square on the seams of interest. Note that the seam to be assessed (the commercially cut edge) is not touched by the die, unless a die cut seam is the desired joint.

2. Along the seam of interest, the tuft yarns are shaved off of the face of the carpet to insure they do not interfere with the measurement. These yarns are shaved off to a distance of at least ½ inch from the carpet edge of interest.

3. Two carpet tile edges are placed face down on a light box (we used The Back Light, Model HPE1218, by Hall Productions) so that the light box will illuminate the seam formed by the tile edge of interest. Any places along the seam where the edges of the tile do not come into direct contact will allow light to transmit through the joint.

4. The seam with the light box backlight is imaged with a CCD camera. We used a Javelin Electronics Chromachip II model JE3462RGB camera in manual mode. The illumination levels of the digital image were set using the iris on the camera lens. The RGB histogram of the image was checked in Adobe Photoshop 6.0 to make sure none of the pixels were clipped at 0 or 255 (8 bit data storage). The data was converted to Adobe Lab color model. The light passing through the seams was adjusted so that its Adobe L value was as close to 255 without clipping the signal. The camera was placed 28 inches above the sample and captured 480×640 pixel resolution.

5. To insure correct spatial calibration, a ruler was imaged in the horizontal and vertical directions of the image. This allows a correspondence between pixel values and length.

6. To insure good digital contrast between the light exiting the seam and the backing of the carpet tile, black construction paper (in the shape of the seam) was placed over the back of the carpet tile (average digital count value of 70 and all values <128) in such a way to cover as much of the carpet backing as possible without clipping the light transmitting through the seam.

7. The two pieces of carpet tile are compressed together by hand with light force and then slowly released.

8. An image is captured of the resulting seam, converted to Adobe Lab color model and split into it separate L, a, and b images. The L image alone was used for the assessment.

9. Image Pro Plus 4.5 was used to count the number of pixels with digital count greater than 128 (representing transmitting intensity through the seam). This actually is an area calculation but it directly correlates to number of pixels. The software was also used to measure the length of the seam.

10. Using the area of light pixels (areas where there is not good contact between seams) and the length of the seam imaged, the average width of non-contact per seam length is calculated.

The results of this assessment are presented graphically in FIG. 32.

In order to evaluate the relative bulk of the pile face on various samples the normal pile layer height was measured from the primary backing to the top of the pile yarns. The average fully extended yarn length from the primary backing was also measured. A Bulk Index was then calculated as the ratio of the extended yarn length to the normal pile height. The standard pile density was then calculated using the following formula.

m/p

where:

m=calculated mass of yarn above primary backing in one square yard based upon shaving representative areas; and

p=height of pile in yards.

The results of the analysis for various samples are set forth in the following table.

Pile Bulk Character

| | | | | Standard Pile |
|---|---|---|---|---|
| | | Extended | Ratio of | Density based |
| | Pile layer | Yarn length | Extended | on pile layer |
| | height under | above | yarn length | height under |
| | normal | primary | divided by | normal |
| | conditions | backing | pile layer | conditions |
| Sample | (inches) | (inches) | height | (oz/cubic yd) |
| A | 0.386 | 0.43 | 1.11 | 2607 |
| B | 0.426 | 0.45 | 1.06 | 2547 |
| C | 0.256 | 0.275 | 1.07 | 1799 |
| D | 0.418 | 0.6 | 1.44 | 2504 |
| E | 0.28 | 0.3 | 1.07 | 4357 |
| F | 0.433 | 0.6 | 1.39 | 2354 |
| G | 0.543 | 0.63 | 1.16 | 2749 |
| H | 0.276 | .6* | 2.17 | 2311 |
| I | 0.539 | 0.55 | 1.02 | 2025** |
| J | 0.304 | 0.34 | 1.12 | 2919** |
| K | 0.181 | 0.41* | 2.27 | 5850** |
| L | 0.173 | 0.32* | 1.85 | 2091 |
| M | 0.165 | 0.18 | 1.09 | 1455 |
| N | 0.15 | 0.28* | 1.87 | 1908 |
| O | 0.177 | 0.19 | 1.07 | 6893 |

*Loop cut and measured
**Value reported by manufacturer based on certified pile weight

### COMPARATIVE EXAMPLE 17

Two tiles of each sample were cut about 6″ wide and 10″ long, leaving one 6″ edge from the outside edge of the original tile unmodified. Two unmodified edges were placed together to form a seam and held in place. A MTS Sintech 1/S materials testing system with a 5.62 lb. load cell was used to pull a Long Tooth Undercoat Rake Just for Dogs across the seam at 3.94 inches/minute. The rake weighs 3.1 ounces and has 20 teeth 11/16″ long evenly spaced along a 3⅞″ length. The rake was pulled across the seam such that the row of teeth was parallel to the seam for a total length of six inches. The force needed to maintain the constant speed was recorded and plotted as a function of position, where the initial position is the zero point. The Testworks 4 software package was used to collect the data, and three data sets were averaged for each sample.

The data were analyzed using Igor. The first inch of the scans was disregarded, since that portion of the data indicates the force needed to set the rake in motion initially. The global maximum value of the force function was found, and then the local minimum just before the maximum was identified. The difference between these two force values is called the “amplitude”. The “amplitude” was then divided by the standard deviation of the force function between the 1″ and 6″ values. This quotient is called the “seam strength”.

The results are set forth in the following table and demonstrate a superior seam in the exemplary product.

| Samples | Amplitude | Stddev | Strength |
|---|---|---|---|
| E | 92.2 | 13.4 | 6.8806 |
| D | 55.2 | 25.4 | 2.17323 |
| C | 135.7 | 23 | 5.9 |
| A | 136.3 | 24.1 | 5.6556 |
| B | 96.4 | 21.5 | 4.48372 |
| O | 13.44 | 8 | 1.68 |
| N | 90.4 | 14.4 | 6.27778 |

While the modular products of the present invention are not limited to carpet tiles for residential use, it is in accordance with at least one embodiment of the present invention that carpet tiles have special applicability to the residential market and, in particular, in the living room and bed rooms of homes as a replacement for broadloom carpet over broadloom pad. In this particular embodiment, it is preferred that the carpet tiles provide a carpet tile installation which substantially looks and feels like broadloom carpet over pad.

Also, in accordance with at least one embodiment of the present invention, the carpet product or construction of the present invention may be in the form of tiles, runners, mats, sheets, area rugs, roll product, and the like. For example, 18″×18″ tiles, 24″×24″ tiles, 36″×36″ tiles, 4′×6′ sheets, 4′×8′ sheets, 4′×12′ sheets, 2′×20′ rolls, 3′×5′ rolls, 4′×40′ rolls, 6′×50′ rolls, and the like.

In accordance with at least one embodiment, the modular product of the present invention is preferably flexible enough to be used on stairs, around corners, and the like. For example, 2′×20′ stair runners that have faces that coordinate or match with the 23″×23″ carpet tiles.

In accordance with yet another embodiment, a system or line or products is provided including carpet tiles, carpet sheets, carpet rolls, and the like which have piles, yarns, patterns, designs, or colors which match or coordinate with other broadloom carpet products, so that one can select matching or coordinating flooring from a full line of carpet type flooring products.

Commonly owned U.S. patent application, Docket No. 5113G, Ser. No. ______, filed Jul. 18, 2002, entitled “Residential Carpet Product and Method” and Ser. No. 10/154,187, filed May 23, 2002, are each hereby incorporated by reference herein, and in international application No. PCT/US02/22854, filed Jul. 18, 2002, is hereby incorporated by reference herein.

The modular carpet tiles or roll product (such as 2, 3, or 4 foot wide roll product) of the present invention facilitate the do-it-yourself installation of carpet in that the pad is attached, the modularity provides for easy handling, tack strips are not required the carpet does not need to be stretched, there are no bulky 12 foot wide rolls, and/or the like. The present tiles or roll product are laid next to each other in abutting relationship. Edge pieces are cut to the desired length and/or width to finish out the space.

In accordance with one example of the present invention, seamability of carpet tiles is tested by laying out at least nine tiles in abutting relationship, and then walking around the layout and judging how many seams (unctions between adjacent tiles) can be seen from each of the four sides of the layout. On a scale of 1-5 with 1 being 100% of the seams being visible, 3 being 50% of the seams, and 5 being 0% of the seams, it is preferred that a particular tile product designed to not show the seams have a score of between about 4-5. In accordance with one particular example, a layout of 9 tiles of the carpet tiles of Example 5 had a score of between about 4 and 5.

The invention may be further understood by reference to the following example which is not to be construed as unduly limiting the invention which is to be defined and construed in light of the appended claims.

### EXAMPLE I

A tufted carpet was produced by the apparatus and process as illustrated and described in relation to FIG. 2. The carpet produced has the configuration illustrated and described in relation to FIG. 3A. The production parameters were as follows:

| | |
|---|---|
| Yarn | 28 Ounces per square yard nylon 6, 6 loop pile |
| | continuous filament. |
| Primary Backing | 4 Ounces per square yard nonwoven polyester. |
| Precoat | 14 Ounces per square yard SBR Latex filled with |
| | 100 parts CaCO.sub.2. |
| Hot Melt Adhesive | 30 Ounces per square yard modified |
| Laminate | polypropylene. |
| Reinforcement | 3 Ounces per square yard nonwoven glass with |
| | acrylic binder. |
| Urethane Foam | 32 Ounces per square yard. |
| Coverage | Urethane Foam Density 16 Pounds per cubic foot. |
| Backing Material | 4 Ounces per square yard nonwoven (80% |
| | polypropylene, 20% polyester). |

It is, of course, to be appreciated that while several potentially preferred embodiments have been shown and described, the invention is in no way to be limited thereto, since modifications may be made and other embodiments of the principles of this invention will occur to those skilled in the art to which this invention pertains. Therefore, it is contemplated by the appended claims to cover any such modifications and other embodiments as incorporate the features of this invention within the true spirit and scope thereof.

What is claimed is:

1. A modular carpet tile especially adapted for residential use, comprising a primary residential carpet face comprising
i) a primary carpet fabric having a pile side and an underside with a plurality of pile forming yarns projecting outwardly from said pile side with said pile forming yarns tufted through a primary backing comprising a multi-component structure of a woven layer and a non-woven material needle punched through said woven layer and said primary carpet fabric having a face weight of about 10-75 oz/yd²;
ii) an adhesive layer extending away from said underside of said primary carpet fabric;
iii) a layer of stabilizing material in contacting relationship with said adhesive layer such that said layer of stabilizing material is held in place at a fixed position below said primary carpet fabric; and
iv) a foam cushion layer bonded to said layer of stabilizing material such that said stabilizing layer is at least partially embedded in said cushion layer and wherein said cushion layer has a thickness of about 1-18 mm and a density of about 1-25 lbs. per cubic foot.

2. The modular carpet tile of claim 1 wherein said face weight is about 20-45 oz/yd².

3. The modular carpet tile of claim 2 wherein said face weight is about 29-45 oz/yd².

4. The modular carpet tile of claim 1 wherein said cushion layer is about 4-12 mm thick.

5. The modular carpet tile of claim 4 wherein said cushion layer is about 5-8 mm thick.

6. The modular carpet tile of claim 1 wherein said cushion density is about 3-15 lbs. per cubic foot.

7. The modular carpet tile of claim 6 wherein said cushion density is about 6-8 lbs. per cubic foot.

8. The modular carpet tile of claim 1 wherein at least a portion of said non-woven material is a low melt material.

9. The modular carpet tile of claim 1 wherein said primary backing is a calendered material.

10. The modular carpet tile of claim 1 wherein said primary backing comprises fused non-woven and woven materials thereby forming an enhanced stability primary backing.

11. The modular carpet tile of claim 1 wherein said woven layer is a woven polypropylene.

12. The modular carpet tile of claim 1 wherein said non-woven material is polyester.

13. The modular carpet tile of claim 8 wherein said low melt material is a low melt or a co-polyester.

14. The modular carpet tile of claim 8 wherein said low melt material comprises a ratio of between about 30% and about 70%, by weight, low melt polyester fiber.

15. The modular carpet tile of claim 1 wherein said primary backing comprises from about 10% to about 100%, by weight, said non-woven.

16. The modular carpet tile of claim 15 comprising about 10% to about 70%, by weight, said non-woven.

17. The modular carpet tile of claim 16 comprising about 10% to about 40%, by weight, said non-woven.

18. The modular carpet tile of claim 1 further comprising a secondary backing disposed adjacent to said foam cushion layer opposite said primary carpet fabric.

19. The modular carpet tile of claim 18 wherein said secondary backing comprises at at least one of polyester and polypropylene.

20. The modular carpet tile of claim 19 wherein said secondary backing consist essentially of polyester and a binder.

21. The modular carpet tile of claim 19 wherein said secondary backing comprises a mixture of polyester, polypropylene and a binder.

22. The modular carpet tile of claim 18 wherein said secondary backing comprises at least one of a woven and nonwoven material.

23. The modular carpet tile of claim 18 wherein said secondary backing comprises at least one woven material.

24. The modular carpet tile of claim 18 wherein said secondary backing comprises at least one non-woven material.

25. The modular carpet tile of claim 18 wherein said secondary backing has a thickness of about 0.01 inches to about 0.19 inches.

26. The modular carpet tile of claim 25 wherein said secondary backing has a thickness of about 0.05 inches to about 0.12 inches.

27. The modular carpet tile of claim 18 wherein said secondary backing comprises at least one material selected from a woven or non-woven textile fabric of polyester, polypropylene, polyester/polypropylene, polyester/polypropylene/acrylic, at least one binder and blends thereof.

28. The modular carpet tile of claim 18 wherein said secondary backing comprises 50-100%, by weight, polyester fiber and 0-50%, by weight, polypropylene fiber.

29. The modular carpet tile of claim 28 wherein said secondary backing comprises 50-100%, by weight, polyester fiber and 0-50%, by weight, polypropylene fiber and 0-30%, by weight, acrylic fiber.

30. The modular carpet tile of claim 18 further comprising a tack layer having a vertical grip of about 0 to about 5 psi.

31. The modular carpet tile of claim 30 wherein said tack layer has a vertical grip of about 0 to about 2 psi.

32. The modular carpet tile of claim 31 wherein said tack layer has a vertical grip of about 0.1 to about 0.6 psi.

33. The modular carpet tile of claim 18 wherein said tack layer has a lateral grip of about 0.05 to about 5 psi.

34. The modular carpet tile of claim 33 wherein said tack layer has a lateral grip of about 0.05 to about 3 psi.

35. The modular carpet tile of claim 1 wherein said tile has a surface covering shape of at least one of square, rectangular, triangular, diamond, hexagonal, octagonal, singular chevron on at least two sides thereof, multiple chevrons on at least two sides thereof, singular lobe on at least one side thereof and combinations thereof.

36. The modular carpet tile of claim 35 wherein said surface covering shape is rectangular.

37. The modular carpet tile of claim 1 wherein said foam cushion layer comprises a mechanically frothed polyurethane foam.

38. A carpet tile installation over a subfloor having substantially the look and feel of residential broadloom carpet over broadloom pad, comprising a plurality of the carpet tiles of claim 1.
